(19) United States
(12) Patent Application Publication
(10) Pub. No.: US 2005/0086484 A1
(43) Pub. Date: Apr. 21, 2005

(54) Identification information embedding apparatus, analysis apparatus, embedding method, analysis method and program

(75) Inventor: Hirofumi Muratani, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 10/935,400

(22) Filed: Sep. 8, 2004

(30) Foreign Application Priority Data
Sep. 30, 2003 (JP) 2003-342229

(51) Int. Cl. H04L 9/00

(52) U.S. Cl. 713/176

(57) ABSTRACT

An identification information embedding apparatus for embedding identification information into an object, comprises a first generator which generates, based on the identification information, an identification information polynomial corresponding to the identification information, an acquisition unit configured to acquire a plurality of remainder polynomials by dividing the identification information polynomial by each of a plurality of relatively prime polynomials, the relatively prime polynomials being pairwise relatively prime, an order of each of the relatively prime polynomials being limited, a second generator which generates, based on the remainder polynomials, a plurality of integers corresponding to the remainder polynomials, respectively, a third generator which generates a plurality of component codes corresponding to the integers, respectively, a fourth generator which generates a collusion-secure code by arranging the component codes in series, and an embedding unit configured to embed the collusion-secure code into the object.

### CROSS-REFERENCE TO RELATED APPLICATIONS

This application is based upon and claims the benefit of priority from prior Japanese Patent Application No. 2003-342229, filed Sep. 30, 2003, the entire contents of which are incorporated herein by reference.

### BACKGROUND OF THE INVENTION

1. Field of the Invention

The present invention relates to an identification information embedding apparatus, method and program for generating collusion-secure codes corresponding to identification information, and embedding them into copies of digital content. It also relates to an identification information analysis apparatus, method and program for acquiring identification information corresponding to collusion-secure codes embedded in illegal copies of digital content resulting from a collusion attack made on legal copies of the digital content in which collusion-secure codes corresponding to identification information are embedded, the former and latter identification information items corresponding to each other.

2. Description of the Related Art

Digital content (e.g., still images, moving images, sounds, music, etc.) comprises a number of digital data items, and includes a portion in which the identity or economical value is maintained even if certain data is changed. By changing data within an allowable range, various types of information can be embedded into digital content. This technique is called “digital watermarking”.

In a method of use of digital watermarking, individual user-detectable identification information items are embedded into copies of digital content before the copies are distributed to a number of users. Since this method enables a user as an originator to be detected from a pirated copy by detecting identification information therefrom, it is expected to be useful for deterring illegal copying in advance or saving a copyright if its infringement occurs. Further, if a user attempts to invalidate the identification information, they must make on copies such an alteration as damages the economical value of the copies, which breaks their motivation to do illegal copying.

Under these circumstances, “a collusion attack” has appeared as a method for enabling illegal copying. A collusion attack utilizes the fact that different identification information items are embedded in different copies. If a plurality of persons gather their respective copies, and compare them in units of, for example, bits, they find different data portions. By altering these different portions, the identification information can be altered or lost.

To protect data from a collusion attack, various methods have been proposed. In one method, one method is a watermarking method, which is resistance against a collusion attack by itself, i.e., which has a property that can specify some or all of the people responsible for a collusion attack is embedded as a digital watermark into the data. Another method utilizes a tracing algorithm based on the collusion-secure code (which specifies identification numbers embedded in content used for a collusion attack to thereby specify the user IDs of the people responsible for a collusion attack). For example, a c-secure code is known as a code that exhibits a high resistance against a collusion attack (see, e.g., D. Boneh and J. Shaw, “Collusion-secure fingerprinting for digital data,” IEEE Trans. on Information Theory, Vol. 44 No. 5, 1897-1905, 1998). Further, a c-secure CRT code is known as a code-constructing code for shortening the code length of the c-secure code (see, e.g., H. Muratani, “A collusion-secure fingerprinting code reduced by Chinese remaindering and its random-error resilience,” Proc. Fourth Information Hiding Workshop, IHW 2001, LNCS 2137, Springer-Verlag, 303-315, 2001). Furthermore, a method for constructing the c-secure CRT code using a polynomial ring has been proposed (see, e.g., M. Kim, J. Shikata, H. Muratani and H. Imai, “Constructing c-secure codes using polynomials over finite fields,” SITA2001, WB-1-3, 2001).

Collusion-secure codes of a shorter code length are demanded.

For example, in the c-secure CRT code, a set of prime numbers or a set of integers pairwise relatively prime (divisor bases) is set as parameters for constructing a code. When prime numbers (or integers pairwise relatively prime) are selected as divisor bases, if they have norms as similar as possible, the code length can be made as short as possible. Further, if the prime numbers that provide a higher density are selected, the code length can be further shortened. However, when the c-secure CRT code is constructed using the ring of rational integers, the prime numbers are liable not to be close to each other, and the density cannot be set to 1. This can be easily understood from, for example, the assumption that the divisor bases are formed of serial prime numbers beginning from prime number “2” that has the minimum norm. Assume here that the number of prime numbers used as the divisor bases is nₚ, the highest number of the prime numbers included in the divisor bases is pₘₐₓ, and the number of the prime numbers that are positive integers higher than 1 and lower than pₘₐₓ and are not included in the divisor bases is nₙₚ. At this time, the density D is defined as D=nₚ/(nₙₚ+nₚ). If nₙₚ=0, D=1. However, it is impossible to select such prime numbers from any ring of rational integers. It is a matter of course that in any ring of rational integers, it is impossible to select prime numbers (or integers pairwise relatively prime) having the same norm.

The same as the above can be said of a watermark technique, other than the above digital watermark technique, which is to be employed for another tracing object, such as another type of information or a substance, the identity, quality or economical value of which does not change even if part of the content is varied.

### BRIEF SUMMARY OF THE INVENTION

According to a first aspect of the invention, there is provided an identification information embedding apparatus for embedding identification information into an object, comprising: a first generator which generates, based on the identification information, an identification information polynomial corresponding to the identification information; an acquisition unit configured to acquire a plurality of remainder polynomials by dividing the identification information polynomial by each of a plurality of relatively prime polynomials, the relatively prime polynomials being pairwise relatively prime, an order of each of the relatively prime polynomials being limited; a second generator which generates, based on the remainder polynomials, a plurality of integers corresponding to the remainder polynomials, respectively; a third generator which generates a plurality of component codes corresponding to the integers, respectively; a fourth generator which generates a collusion-secure code by arranging the component codes in series; and an embedding unit configured to embed the collusion-secure code into the object.

According to a second aspect of the invention, there is provided an identification information embedding apparatus for embedding, as watermark information, identification information into an object, comprising: a first generator which generates, based on the identification information, an element included in a particular ring in which a Chinese remainder theorem holds, the element corresponding to the identification information; an acquisition unit configured to acquire a plurality of remainders by performing, on the element, an operation corresponding to division, using each of a plurality of prime ideals included in the particular ring, the prime ideals being pairwise relatively prime and having limited norms; a second generator which generates, based on the remainders, a plurality of integers corresponding to the remainders, respectively; a third generator which generates a plurality of component codes corresponding to the integers, respectively; a fourth generator which generates a collusion-secure code by arranging the component codes in series; and an embedding unit configured to embed the collusion-secure code into the object.

According to a third aspect of the invention, there is provided an identification information analysis apparatus for acquiring identification information embedded in a plurality of legal copies of a content from a plurality of illegal copies of the content resulting from a collusion attack made on the legal copies of the content, a plurality of collusion-secure codes corresponding to different identification information items being embedded in the legal copies of the content, respectively, comprising: a code acquisition unit configured to acquire, from a copy of the content, a code extracted as a collusion-secure code; a division unit configured to divide the code into a plurality of component codes; a position acquisition unit configured to acquire positional information indicating a position of an altered portion of each of the component codes if each of the component codes is altered, and a reference position in each of the component codes if each of the component codes fails to be altered; and an information acquisition unit configured to acquire the identification information embedded in the legal copies of the content from the positional information concerning each of the component codes, and reference positional information obtained when all of the component codes of the collusion-secure code corresponding to the identification information fail to be altered, wherein each of the collusion-secure codes is generated by generating an identification information polynomial corresponding to the identification information, based on the identification information, dividing the identification information polynomial by each of a plurality of relatively prime polynomials corresponding to the identification information to acquire remainder polynomials, generating a plurality of integers corresponding to the remainder polynomials, respectively, based on the remainder polynomials, generating the component codes corresponding to the integers, respectively, and arranging the component codes in series, the relatively prime polynomials being pairwise relatively prime, an order of each of the relatively prime polynomials being limited.

According to a fourth aspect of the invention, there is provided an identification information analysis apparatus for acquiring identification information embedded in a plurality of legal copies of a content from a plurality of illegal copies of the content resulting from a collusion attack made on the legal copies of the content, a plurality of collusion-secure codes corresponding to different identification information items being embedded in the legal copies of the content, respectively, comprising: a code acquisition unit configured to acquire, from a copy of the content, a code extracted as a collusion-secure code; a division unit configured to divide the code into a plurality of component codes; a position acquisition unit configured to acquire positional information indicating a position of an altered portion of each of the component codes if each of the component codes is altered, and a reference position in each of the component codes if each of the component codes fails to be altered; and an information acquisition unit configured to acquire the identification information embedded in the legal copies of the content from the positional information concerning each of the component codes, and reference positional information obtained when all of the component codes of the collusion-secure code corresponding to the identification information fail to be altered, wherein the collusion-secure code is generated by generating an element included in a particular ring in which a Chinese remainder theorem holds, performing an operation corresponding to division on the element using each of a plurality of prime ideals included in the particular ring, to acquire remainders, generating a plurality of integers corresponding to the remainders, respectively, generating the component codes corresponding to the integers, respectively, and arranging the component codes in series, the prime ideals being pairwise relatively prime and having respective norms limited.

According to a fifth aspect of the invention, there is provided an identification information embedding method for embedding identification information into an object, comprising: generating, based on the identification information, an identification information polynomial corresponding to the identification information; acquiring a plurality of remainder polynomials by dividing the identification information polynomial by each of a plurality of relatively prime polynomials, the relatively prime polynomial being pairwise relative prime, an order of each of the relatively prime polynomials being limited; generating, based on the remainder polynomials, a plurality of integers corresponding to the remainder polynomials, respectively; generating a plurality of component codes corresponding to the integers, respectively; generating a collusion-secure code by arranging the component codes in series; and embedding the collusion-secure code into the object.

According to a sixth aspect of the invention, there is provided an identification information embedding method for embedding, as watermark information, identification information into an object, comprising: generating, based on the identification information, an element included in a particular ring in which a Chinese remainder theorem holds, the element corresponding to the identification information; acquiring a plurality of remainders by performing, on the element, an operation corresponding to division, using each of a plurality of prime ideals included in the particular ring, the prime ideals being pairwise relatively prime and having limited norms; generating, based on the remainders, a plurality of integers corresponding to the remainders, respectively; generating a plurality of component codes corresponding to the integers, respectively; generating a collusion-secure code by arranging the component codes in series; and embedding the collusion-secure code into the object.

According to a seventh aspect of the invention, there is provided an identification information analysis method of acquiring identification information embedded in a plurality of legal copies of a content from a plurality of illegal copies of the content resulting from a collusion attack made on the legal copies of the content, a plurality of collusion-secure codes corresponding to different identification information items being embedded in the legal copies of the content, respectively, comprising: acquiring, from a copy of the content, a code extracted as a collusion-secure code; dividing the code into a plurality of component codes; acquiring positional information indicating a position of an altered portion of each of the component codes if each of the component codes is altered, and a reference position in each of the component codes if each of the component codes fails to be altered; and acquiring the identification information embedded in the legal copies of the content from the positional information concerning each of the component codes, and reference positional information obtained when all of the component codes of the collusion-secure code corresponding to the identification information fails to be altered, wherein each of the collusion-secure codes is generated by generating an identification information polynomial corresponding to the identification information, based on the identification information, dividing the identification information polynomial by each of a plurality of relatively prime polynomials corresponding to the identification information to acquire remainder polynomials, generating a plurality of integers corresponding to the remainder polynomials, respectively, based on the remainder polynomials, respectively, generating the component codes corresponding to the integers, respectively, and arranging the component codes in series, the relatively prime polynomials being pairwise relatively prime, an order of each of the relatively prime polynomials being limited.

According to an eighth aspect of the invention, there is provided an identification information analysis method of acquiring identification information embedded in a plurality of legal copies of a content from a plurality of illegal copies of the content resulting from a collusion attack made on the legal copies of the content, a plurality of collusion-secure codes corresponding to different identification information items being embedded in the legal copies of the content, respectively, comprising: acquiring, from a copy of the content, a code extracted as a collusion-secure code; dividing the code into a plurality of component codes; acquiring positional information indicating a position of an altered portion of each of the component codes if each of the components is altered, and a reference position in each of the component codes if each of the component codes fails to be altered; and acquiring the identification information embedded in the legal copies of the content from the positional information concerning each of the component codes, and reference positional information obtained when all of the component codes of the collusion-secure code corresponding to the identification information fails to be altered, wherein the collusion-secure code is generated by generating an element included in a particular ring in which a Chinese remainder theorem holds, performing an operation corresponding to division on the element using each of a plurality of prime ideals included in the particular ring, to acquire remainders, generating a plurality of integers corresponding to the remainders, respectively, generating component codes corresponding to the integers, respectively, and arranging the component codes in series, the prime ideals being pairwise relatively prime and having respective norms limited.

According to a ninth aspect of the invention, there is provided a program stored in a computer readable medium for causing a computer to function as an identification information embedding apparatus for embedding identification information into an object, the program comprising: means for instructing the computer to generate, based on the identification information, an identification information polynomial corresponding to the identification information; means for instructing the computer to acquire a plurality of remainder polynomials by dividing the identification information polynomial by each of a plurality of relatively prime polynomials, the relatively prime polynomials being pairwise relatively prime, an order of each of the relatively prime polynomials being limited; means for instructing the computer to generate, based on the remainder polynomials, a plurality of integers corresponding to the remainder polynomials, respectively; means for instructing the computer to generate a plurality of component codes corresponding to the integers, respectively; means for instructing the computer to generate a collusion-secure code by arranging the component codes in series; and means for instructing the computer to embed the collusion-secure code into the object.

According to a tenth aspect of the invention, there is provided a program stored in a computer readable medium for causing a computer to function as an identification information embedding apparatus for embedding identification information into an object, comprising: means for instructing the computer to generate, based on the identification information, an element included in a particular ring in which a Chinese remainder theorem holds, the element corresponding to the identification information; means for instructing the computer to acquire a plurality of remainders by performing, on the element, an operation corresponding to division, using each of a plurality of prime ideals included in the particular ring, the prime ideals being pairwise relatively prime and having limited norms; means for instructing the computer to generate, based on the remainders, a plurality of integers corresponding to the remainders, respectively; means for instructing the computer to generate a plurality of component codes corresponding to the integers, respectively; means for instructing the computer to generate a collusion-secure code by arranging the component codes in series; and means for instructing the computer to embed the collusion-secure code into the object.

According to an eleventh aspect of the invention, there is provided a program stored in a computer readable medium for causing a computer to function as an identification information analysis apparatus for acquiring identification information embedded in a plurality of legal copies of a content from a plurality of illegal copies of the content resulting from a collusion attack made on the legal copies of the content, a plurality of collusion-secure codes corresponding to different identification information items being embedded in the legal copies of the content, respectively, comprising: means for instructing the computer to acquire, from a copy of the content, a code extracted as a collusion-secure code; means for instructing the computer to divide the code into a plurality of component codes; means for instructing the computer to acquire positional information indicating a position of an altered portion of each of the component codes if each of the component codes is altered, and a reference position in each of the component codes code if each of the component codes fails to be altered; and means for instructing the computer to acquire the identification information embedded in the legal copies of the content from the positional information concerning each of the component codes, and reference positional information obtained when all of the component codes of the collusion-secure code corresponding to the identification information fail to be altered, wherein each of the collusion-secure codes is generated by generating an identification information polynomial corresponding to the identification information, based on the identification information, dividing the identification information polynomial by each of a plurality of relatively prime polynomials corresponding to the identification information to acquire remainder polynomials, generating a plurality of integers corresponding to the remainder polynomials, respectively, based on the remainder polynomials, respectively, generating the component codes corresponding to the integers, respectively, and arranging the component codes in series, the relatively prime polynomials being pairwise relatively prime, an order of each of the relatively prime polynomials being limited.

According to a twelfth aspect of the invention, there is provided a program stored in a computer readable medium for enabling a computer to function as an identification information analysis apparatus for acquiring identification information embedded in a plurality of legal copies of a content from a plurality of illegal copies of the content resulting from a collusion attack made on the legal copies of the content, a plurality of collusion-secure codes corresponding to different identification information items being embedded in the legal copies of the content, respectively, comprising: means for instructing the computer to acquire, from a copy of the content, a code extracted as a collusion-secure code; means for instructing the computer to divide the code into a plurality of component codes; means for instructing the computer to acquire positional information indicating a position of an altered portion of each of the component codes if each of the component codes is altered, and a reference position in each of the component codes if each of the component codes fails to be altered; and means for instructing the computer to acquire the identification information embedded in the legal copies of the content from the positional information concerning each of the component codes, and reference positional information obtained when all of the component codes of the collusion-secure code corresponding to the identification information fail to be altered, wherein each of the collusion-secure codes is generated by generating an element included in a particular ring in which a Chinese remainder theorem holds, performing an operation corresponding to division on the element using each of a plurality of prime ideals included in the particular ring, to acquire remainders, generating a plurality of integers corresponding to the remainders, respectively, generating the component codes corresponding to the integers, respectively, and arranging the component codes in series, the prime ideals being pairwise relatively prime and having respective norms limited.

### BRIEF DESCRIPTION OF THE SEVERAL VIEWS OF THE DRAWING

FIG. 1 is a schematic view illustrating a configuration example of a contents circulation system including a digital watermark embedding apparatus and analysis apparatus according to an embodiment of the invention;

FIG. 2 is a block diagram illustrating a configuration example of the digital watermark embedding apparatus of the embodiment;

FIG. 3 is a block diagram illustrating a configuration example of the digital watermark analysis apparatus of the embodiment;

FIG. 4 is a schematic flowchart useful in explaining a procedure example of the digital watermark embedding apparatus of the embodiment;

FIG. 5 is a block diagram illustrating a configuration example of a code generator incorporated in the digital watermark embedding apparatus of the embodiment;

FIG. 6 is a block diagram illustrating a configuration example of a component code generator incorporated in the code generator of the embodiment;

FIG. 7 is a view useful in explaining a component code example generated by the digital watermark embedding apparatus of the embodiment;

FIG. 8 is a view useful in explaining a method for acquiring a remainder string from a target content detected by the digital watermark analysis apparatus of the embodiment;

FIG. 9 is a block diagram illustrating a configuration example of a decoder incorporated in the digital watermark analysis apparatus of the embodiment;

FIG. 10 is a block diagram illustrating a configuration example of a component code decoder incorporated in the decoder of the embodiment;

FIG. 11 is a view useful in explaining processing performed by a code division unit incorporated in the component code decoder of the decoder;

FIG. 12 is a view illustrating a configuration example of a residue pair detector incorporated in the decoder of the embodiment;

FIG. 13 is a block diagram illustrating a configuration example of a tracing processing unit incorporated in the decoder of the embodiment;

FIG. 14 is a block diagram illustrating a configuration example of a tracing unit incorporated in the tracing processing unit of the decoder of the embodiment;

FIG. 15 is a block diagram illustrating a configuration example of the digital watermark embedding apparatus of the embodiment related to a compound;

FIG. 16 is a block diagram illustrating another configuration example of the digital watermark embedding apparatus of the embodiment related to a compound; and

FIG. 17 is a block diagram illustrating a configuration example of the digital watermark analysis apparatus of the embodiment related to a compound.

### DETAILED DESCRIPTION OF THE INVENTION

Embodiments of the invention will be described in detail with reference to the accompanying drawings.

A description will be given of the case where different identification information items are embedded as digital watermark information into copies of a single digital content (e.g., a still image, moving image, sound, music, etc.), and are traced. In the description below, user identifiers (user IDs) for users corresponding to the copies are mainly used as identification information. The users utilize the copies. For example, the users are persons to whom the copies are transferred, lent or provided via a recording medium or communication medium. However, information obtained by subjecting a user ID to predetermined conversion may be used as identification information. Alternatively, information other than a user ID, or information obtained by converting information other than a user ID may be used as identification information. A user ID may contain information concerning a date and time of use, place of use, etc.

It is a matter of course that other various watermark information items (e.g., information concerning the copyright holder of a content, rights such as copyright, a condition of use of a content, secret information needed to use a content, copy control information, any combination of them, etc.) may be embedded and detected for various purposes (e.g., for control of use, copyright holder protect including copy control, acceleration of quadratic use, etc.). If other watermark information items are utilized, the portions of copies related to them may have an arbitrary structure.

The configuration views provided below may be realized as device function block diagrams, software (program) function module views, or flowcharts of procedure.

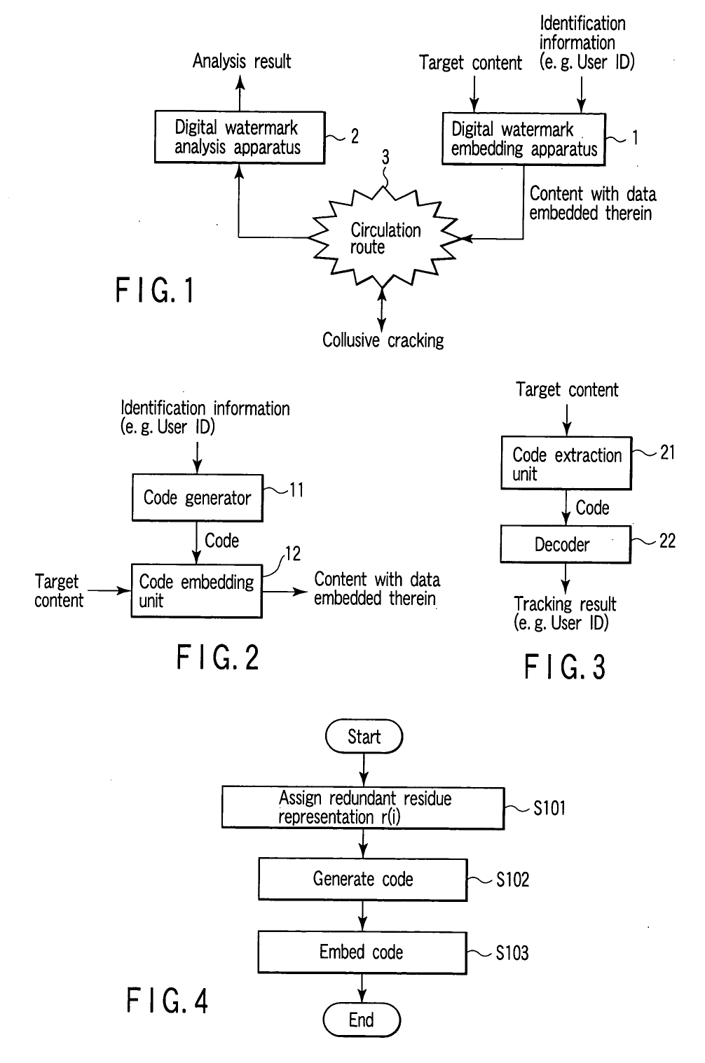

FIG. 1 is a conceptual diagram illustrating a system for enabling a digital watermark embedding apparatus and digital watermark analysis apparatus to be utilized.

The digital watermark embedding apparatus 1 and digital watermark analysis apparatus 2 shown in FIG. 1 are provided and managed at, for example, a contents provider.

Alternatively, the digital watermark embedding apparatus 1 may be provided at a user side, while the digital watermark analysis apparatus 2 may be provided at a contents provider. In this case, the apparatus 1 may be incorporated in or connected to, for example, a user system for utilizing contents, such as a computer system, dedicated apparatus, etc.

In the first-mentioned case, watermark information is embedded into copies of digital content before the copies are transferred to a user. In the latter case, the embedding of watermark information is performed before the copies are used by a user.

Any appropriate method may be employed in the digital watermark embedding apparatus 1 for embedding desired watermark data into digital content, or in the digital watermark analysis apparatus 2 for analyzing the watermark data in the digital content. See, for example, “Foundations of Digital Watermarking” by Kineo Matsui, published in 1998 by Morikita Publisher.

The digital watermark embedding apparatus 1 can be realized as software (program) or hardware. Similarly, the digital watermark analysis apparatus 2 can be realized as software (program) or hardware. Further, when both the digital watermark embedding apparatus 1 and digital watermark analysis apparatus 2 are utilized by a contents provider, they can be realized as one unit.

FIG. 2 shows a configuration example of the digital watermark embedding apparatus 1.

As seen from FIG. 2, the digital watermark embedding apparatus 1 comprises a code generator 11 for generating a collusion-secure code corresponding to to-be-embedded identification information (e.g., a user ID), and a code embedding unit 12 for embedding the generated collusion-secure code (embedded code) into a target content.

Upon receiving a target content and identification information (e.g., a user ID for a target user to whom the content is provided) to be embedded into it, the digital watermark embedding apparatus 1 generates a collusion-secure code corresponding to the identification information, and outputs the content with the collusion-secure code as copies (e.g., copies for a user with the user ID). When other watermark information is utilized, it is embedded.

If identification information is not a user ID, and the user ID is imparted, the user ID is converted into identification information as a pre-process, for example.

The copies of the content with the identification information generated by the digital watermark embedding apparatus 1 are circulated via a circulation route 3 including a recording medium or communication medium. A collusion attack using a plurality of copies is performed through the circulation route 3.

FIG. 3 shows a configuration example of the digital watermark analysis apparatus 2.

As seen from FIG. 3, the digital watermark analysis apparatus 2 comprises a code extraction unit 21 and decoder 22.

The code extraction unit 21 extracts an embedded code from a copy of a target content (code extraction is performed assuming that a collusion-secure code that is not subjected to a collusion attack is embedded in the copy, regardless of whether the collusion attack has occurred). Actually, however, data subjected to a collusion attack and hence altered may be extracted, as well as an originally embedded collusion-secure code.

The decoder 22 executes a tracing algorithm, described later, on the extracted code, thereby detecting (estimating) that there was no collusion attack, or detecting (estimating) one or more identification information items (e.g., user IDs) corresponding to collusion-secure codes embedded in copies that might have been used for a collusion attack.

If, for example, the detected identification information is not a user ID, and hence it is necessary to acquire a user ID, it is subjected to post processing, such as conversion thereof into a user ID.

There exist various tracing algorithms and redundant residue representation methods (described later) for providing such tracing algorithms. For example, there is a probabilistic method for allowing a certain rate of erroneous detection to detect the identification information of people responsible for a collusion attack, or a deterministic method for detecting it without erroneous detection.

The embodiment will be described in more detail.

In the description below, it is assumed that a unique redundant residue representation is assigned to each identification information item. A method can be utilized in which a plurality of identification information items correspond to a single redundant residue representation.

Firstly, the digital watermark embedding apparatus 1 will be described.

FIG. 4 illustrates a schematic procedure example.

In this example, identification information is formed of an integer.

At first, the code generator 11 obtains a number N (N>1) of integers r(1), r(2), . . . , r(N) (this will be referred to as a “redundant residue representation”) corresponding to identification information to be embedded in a target copy, based on this identification information and predetermined divisor bases, and assigns the redundant residue representation to the identification information (step S101). This will be described later in detail. The redundant residue representation may be prestored or obtained when needed.

Since the redundant residue representation uniquely corresponds to the identification information, if a redundant residue representation {r(1), r(2), . . . , r(N)} corresponding to certain correct identification information is imparted, identification information corresponding thereto is uniquely specified. Tracing algorithms are used to detect identification information that was used for a collusion attack, from a residue pair representation extracted from a copy on which the collusion attack was performed.

Subsequently, the code generator 11 generates a collusion-secure code corresponding to identification information to be embedded into a target copy, from a redundant residue representation {r(1), r(2), . . . , r(N)} corresponding to the identification information (step S102). A collusion-secure code corresponding to each identification information item may be pre-stored or generated when necessary.

A collusion-secure code corresponding to each identification information item is generated by acquiring component codes W(1), W(2), . . . , W(N) corresponding to a number N of integers r(1), r(2), . . . , r(N), respectively, and arranging them in series.

A component code W(i) corresponding to an integer r(i) can be formed of, for example, Γ0(n, t) code. Γ0(n, t) code is formed by arranging units B(0) to B(n-2) in series. Each unit B(j) represents a number t of serial bits, each bit being “1” or “0”. Further, all units B(0) to B(n-2) are formed of “1” bits or “0” bits. Alternatively, units B(0) to B(m-1) are formed of “0” bits and the other units B(m) to B(n-2) are formed of “1” bits.

For example, if r(1) is 0, 1, 2, 3 or 4, n=5. In this case, if t=5, Γ0(5, 5) code is as follows:
If r(1)=0, W(1)=11111111111111111111
If r(1)=1, W(1)=00000111111111111111
If r(1)=2, W(1)=00000000001111111111
If r(1)=3, W(1)=00000000000000011111
If r(1)=4, W(1)=00000000000000000000

A collusion-secure code can be generated by arranging in series the thus-obtained component codes W(i) corresponding to r(i).

In this code, “1” or “0” bits are arranged in series in units of a number t of bits, and there is no case where a certain number of “1” or “0” bits less than the number t of bits exist isolatedly (in the above case, there is no case where a certain number of “1” or “0” bits less than 5 bits exist isolatedly). Accordingly, if a certain number of “1” or “0” bits less than the number t of bits do exist isolatedly, it is estimated that a collusion attack has been performed. On the other hand, if a certain number of “1” or “0” bits less than the number t of bits do not exist isolatedly, it is estimated that no a collusion attack is performed.

The thus-generated collusion-secure code is embedded into a target content by the code embedding unit 12 of the digital watermark embedding apparatus 1 (step S103). Any method may be used to embed the generated collusion-secure code.

The code generator 11 of the embodiment will be described in detail.

A method using divisor bases, employed in the embodiment for calculating a redundant residue representation from identification information, utilizes, as a ring for selecting divisor bases therefrom, a certain ring included in rings (called Dedekind rings) in which the Chinese remainder theorem holds. In the certain ring, prime ideals that have the same norm or provide a density of 1 can be selected as divisor bases. In other words, in the embodiment, in a c-secure CRT code on a Dedekind ring, divisor bases containing prime ideals that are pairwise relatively prime and have the same norm or provide a density of 1 are selected, thereby shortening the code length of the c-secure CRT code, and enabling the code to be embedded into a smaller-size content.

In the embodiment, a description will be given of the case where a polynomial ring (a ring formed of a set of polynomials) on a finite field is used as an example of the above-mentioned ring.

Firstly, in the embodiment, assume that divisor bases are formed of prime ideals that are pairwise relatively prime. If the Dedekind ring is a polynomial ring on a finite field, the divisor bases are formed of irreducible polynomials (polynomials that cannot be expressed by the product of polynomials) that are pairwise relatively prime. However, it is not necessary that the polynomial is irreducible, it is sufficient that the polynomial is pairwise relatively prime.

Further, it is preferable in the embodiment that the prime ideals that are pairwise relatively prime and provide the divisor bases have the same norm (i.e., the same size, or the same number of remainders).

If the Dedekind ring is a polynomial ring on a finite field Fq (={0, 1, . . . , q−1}), the norm (i.e., the size) of the polynomials of each ring is q^{d} where d represents the order of a monic polynomial (which has a maximum-order term with a coefficient of 1). Since q in q^{d} is a constant, to provide the same norm, it is sufficient if d's of the polynomials are made equal to each other.

Accordingly, when irreducible polynomials used as divisor bases are selected from a polynomial ring on the finite field Fq (={0, 1, . . . , q−1}), it is preferable to make the order d of the irreducible polynomials equal. However, d=0 should be excluded (if d=0, the polynomial ring becomes equal to the ring of rational integers).

Furthermore, when the prime ideals of the divisor bases that are pairwise relatively prime are made to have the same norm, it is preferable to select those of the prime ideals belonging to a Dedekind ring, which have the minimum norm. If the Dedekind ring is a polynomial ring on a finite field, prime ideals of the minimum norm are linear monic irreducible polynomials. In this case, irreducible polynomials that provide a density of 1 can be selected. Further, if irreducible polynomials as the divisor bases are all set to linear monic irreducible polynomials included in a polynomial ring on the finite field Fq (={0, 1, . . . , q−1}), the norms are all given as q.

The fact that if divisor bases formed of minimum-norm prime ideals are selected, the divisor bases provide a density of 1 will be explained, using a polynomial ring on the finite field Fq.

There exist a number q of linear monic irreducible polynomials. If q is a prime number, a number q(q−1)/2 of quadratic monic irreducible polynomials exist. On the other hand, a number q of linear monic polynomials and a number q² of quadratic monic polynomials exist as a whole. From this, the number of linear irreducible polynomials/the number of linear polynomials (=1)>the number of quadratic irreducible polynomials/the number of quadratic polynomials (=(q−1)/2q). In general, the number of d-th-degree irreducible polynomials/the number of d-th-degree polynomials>the number of (d+1)-th-degree irreducible polynomials/the number of (d+1)-th-degree polynomials.

Accordingly, the density can be enhanced in the case where lower-degree irreducible polynomials are included in the divisor bases, compared to the case where higher-degree irreducible polynomials are included in the divisor bases. In particular, if the polynomials included in the divisor bases are all linear monic irreducible polynomials, the density can be made 1.

Even if some of the prime ideals included in the divisor bases have different norms, an advantage in conformance with that obtained where all prime ideals as the divisor bases have the same norm can be obtained. For example, even if some of the irreducible polynomials included in the divisor bases differ in order, an advantage in conformance with that obtained where all irreducible polynomials as the divisor bases have the same norm can be obtained.

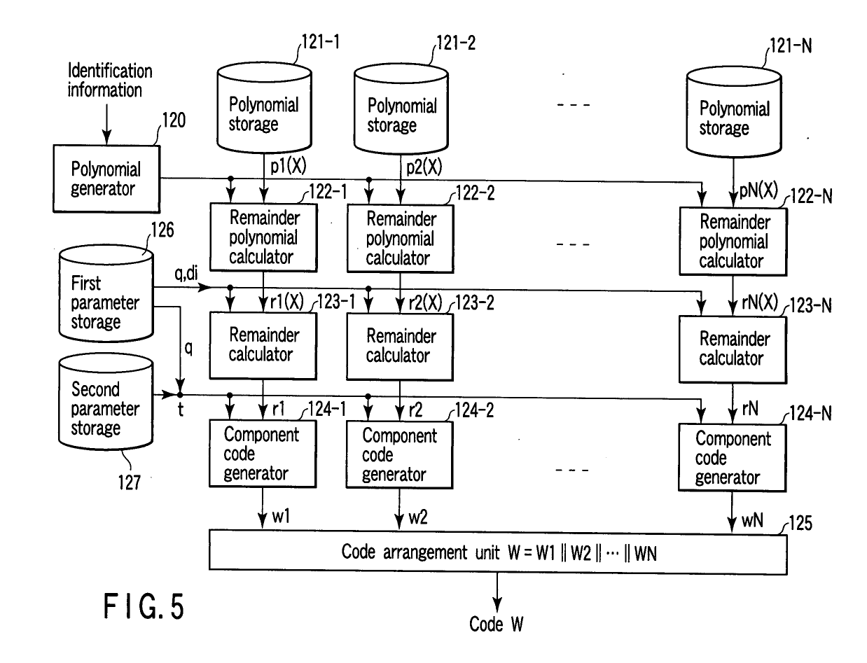

FIG. 5 is a configuration example of the code generator 11.

In this example, Γ0(n, t) code is used as a component code.

As seen from FIG. 5, the code generator 11 comprises a polynomial generator 120, a number N of irreducible polynomial storages 121-1 to 121-N, a number N of remainder polynomial calculators 122-1 to 122-N, a number N of remainder calculators 123-1 to 123-N, and a number N of component code generators 124-1 to 124-N. The code generator 11 further comprises a code arrangement unit 125, a first parameter storage 126, and a second parameter storage 127.

Assume here that a Dedekind ring R is a polynomial ring on a finite field Fq (={0, 1, . . . , q−1}).

Identification information u is, for example, an integer falling within a predetermined range.

The polynomial generator 120 receives the identification information u, and generates, based on this identification information, an element of the Dedekind ring R that corresponds to the identification information. The element is specifically a polynomial (hereinafter referred to as an “identification information polynomial”) u(x) included in the polynomial ring on the finite field Fq (={0, 1, . . . , q−1}). The identification information polynomial u(x) is supplied to each remainder polynomial calculator 122-i (i=1 to N).

Each irreducible polynomial storage 121-i (i=1 to N) stores an i-th prime ideal which is one of prime ideals that are pairwise relatively prime. More specifically, each irreducible polynomial storage 121-i stores a pre-selected (an i-th) irreducible polynomial pi(x) which is one of irreducible polynomials that are pairwise relatively prime and included in the irreducible polynomials of the polynomial ring on the finite field Fq (={0, 1, . . . , q−1}), the irreducible polynomials pi(x) being pairwise relatively prime. These irreducible polynomials pi(x) are supplied to the respective corresponding remainder polynomial calculators 122-i (i=1 to N).

Each remainder polynomial calculator 122-i (i=1 to N) calculates a remainder of the Dedekind ring R corresponding to the identification information by performing, on the element of the Dedekind ring R corresponding to the identification information, an operation equivalent to division using the i-th prime ideal. More specifically, a polynomial (hereinafter referred to as a “remainder polynomial”) ri(x) (=u(x) mod pi(x)) is obtained by dividing the identification information polynomial u(x) by the irreducible polynomial pi(x) corresponding to the calculator 122-i.

The first parameter storage 126 stores information concerning norms, i.e., the number q of the elements of the finite field Fq, and the order di (or data that can specify the order) of each irreducible polynomial pi(x). The number q is supplied to all the remainder calculators 123-i (i=1 to N) and also to all the component code generators 124-i. The order di of each irreducible polynomials pi(x) is supplied to the corresponding remainder calculator 123-i (i=1 to N).

Each remainder calculator 123-i (i=1 to N) converts the remainder of the Dedekind ring R into an integer (hereinafter referred to as a “remainder”) ri. Specifically, each remainder polynomial ri(x) is converted into the integer ri, based on the number q of the elements of the finite field Fq and the order di of the corresponding irreducible polynomials pi(x). The string of the remainders ri output from all the remainder calculators 123-i, i.e., {r1, r2, . . . , rN}, is the above-mentioned redundant residue representation.

Assuming that the string {r1(x), r2(x), . . . , rN(x)} of the remainder polynomials ri(x) output from all the remainder polynomial calculators 122-i is a standard remainder polynomial string, each remainder calculator 123-i (i=1 to N) converts the corresponding standard remainder polynomial string into a redundant residue representation.

The second parameter storage 127 stores a component code parameter, specifically, a component code block length t. This block length t is supplied to each component code generator 124-i (i=1 to N).

Each component code generator 124-i (i=1 to N) generates a component code W(i) from the corresponding remainder ri. Specifically, each component code generator 124-i (i=1 to N) generates a component code formed of the aforementioned Γ0(q, t) code that represents the remainder ri acquired by the remainder calculator 123- i (i=1 to N) based on the coder parameter t stored in the second parameter storage 127.

The code arrangement unit 125 arranges, in series, the component codes W(1), W(2), . . . , W(N) generated by the component code generators 124-1, 124-2, . . . , 124-N, thereby generating a collusion-secure code W=W(1)∥W(2)∥ . . . ∥W(N) as digital watermark information.

A description will now be given of the process ranging from the input of identification information to the calculation of a redundant residue representation.

Specifically, a description will be given of an identification information coding method in which the elements u of an identification information set U are expressed by the respective combinations <q1, . . . , qN> of the elements qi of a plurality of sets Qi (i=1 to N).

(i) The identification information u is uniquely determined from an arbitrary combination <qi(1), . . . , qi(k)> included in the combinations <q1, . . . , qN>, k being an integer less than N.

(ii) Concerning an arbitrary number k of sets Qi(1), . . . , Qi(k), the product of the numbers of the elements belonging to these sets |Qi(1)|x . . . x |Qi(k)| is not less than the number |U| of the elements included in the identification information set U (the sets Qi(1), . . . , Qi(k) are a number k of different sets selected from Q1, . . . , QN).

(iii) Under these conditions, assume that the sets Q1, . . . , QN are nonnegative integer sets smaller than the norms of the elements e1, . . . , eN of a certain Dedekind ring, or sets containing elements corresponding to the elements e1, . . . , eN.

(iv) The number N of Dedekind ring elements e1, . . . , eN may be those of the prime ideals of the Dedekind ring that have the minimum norm (except for norm 1) (to this end, q not less than N is selected). Alternatively, the elements e1, . . . , eN may be set so that one or more elements, less than the number N of elements, included in the elements e1, . . . , eN have the minimum norm (except for norm 1).

More specifically, if a polynomial ring on a finite field F₃(={0, 1, 2}) is used as a Dedekind ring, the linear monic irreducible polynomials are x, x−1 and x−2, and their norm is q^{d}=3¹=3. Further, if only linear monic irreducible polynomials are selected from the polynomials on the finite field F₃, {x, x−1, x−2}, for example, are selected as divisor bases, setting N=3 and k=2. On the other hand, if only quadratic monic irreducible polynomials are selected as divisor bases from the polynomials on the finite field F₃, their norm is q^{d}=3²=9. In this case, {x²+1, x²+x+2, x²+2x+2}, for example, are selected as divisor bases. Further, divisor bases may be formed of monic irreducible polynomials of different orders (for example, {x²+1, x−1, x−2} are selected).

The identification information u is set to, for example, u ε{0, 1, . . . , q^{k}−-1}. If, for example, q=3 and k=2, the identification information is u ε{0, 1, . . . , 8}.

Upon receiving identification information u ε{0, 1, . . . , q^{k}−1}, the polynomial generator 120 calculates:
u=Σq^{j}uⱼ(the range of the sum is j=0 to k −1)
From this, the generator 120 calculates coefficients u₀, u₁, . . . , uₖ₋₁. From the coefficients, the generator 120 creates the following identification information u(x):
u=Σuⱼx^{j}(the range of the sum is j=0 to k−1)

If q=3 and k=2, the following coefficients u₀ and u₁ are obtained for u=0 to 8:
u=0 . . . u₀=0, u₁=0
u=1 . . . u₀=0, u₁=1
u=2 . . . u₀=0, u₁=2
u=3 . . . u₀=1, u₁=0
u=4 . . . u₀=1, u₁=1
u=5 . . . u₀=1, u₁=2
u=6 . . . u₀=2, u₁=0
u=7 . . . u₀=2, u₁=1
u=8 . . . u₀=2, u₁=2

Further, the following identification information polynomials u(x) are obtained for u=0 to 8:
u=0 . . . 0
u=1 . . . 1
u=2 . . . 2
u=3 . . . x
u=5 . . . x+1
u=5 . . . x+2
u=6 . . . 2x
u=7 . . . 2x+1
u=8 . . . 2x+2

Each of the number N of irreducible polynomial storages 121-i stores irreducible polynomials pi(x) (i=1, . . . , N) selected as divisor bases. The selected irreducible polynomials are linear monic irreducible polynomials included in a polynomial ring on the finite field Fq. Accordingly, pi(x)=x−ai, and ai εFq, ai being different values. For example, the irreducible polynomial storages 121-1, 121-2 and 121-3 store x, x−1 and x−2, respectively.

Each of the number N of remainder polynomial calculators 122-i calculates a remainder polynomial ri(x)=u(x) mod pi(x), based on the irreducible polynomial pi(x) supplied from the corresponding irreducible polynomial storage 121-i and the identification information polynomial u(x) supplied from the polynomial generator 120.

If, for example, {x, x−1, x−2} are selected as divisor bases, the following remainder polynomials ri(x) are obtained for u=0 to 8:
u=0 . . . r1(0)=0, r2(0)=0, r3(0)=0
u=1 . . . r1(1)=1, r2(1)=1, r3(1)=1
u=2 . . . r1(2)=2, r2(2)=2, r3(2)=2
u=3 . . . r1(3)=0, r2(3)=1, r3(3)=2
u=4 . . . r1(4)=1, r2(4)=2, r3(4)=0
u=5 . . . r1(5)=2, r2(5)=0, r3(5)=1
u=6 . . . r1(6)=0, r2(6)=2, r3(6)=1
u=7 . . . r1(7)=1, r2(7)=0, r3(7)=2
u=8 . . . r1(8)=2, r2(8)=1, r3(8)=0

Each of the number N of remainder polynomial calculators 123-i calculates a remainder ri based on a remainder polynomial ri(x) supplied from the corresponding remainder polynomial calculator 122-i, q supplied from the first parameter storage 127, and the order di of the corresponding irreducible polynomial pi(x).

Each of the number N of remainder polynomial calculators 123-i converts the corresponding remainder polynomial ri(x) into a uniquely assigned nonnegative integer not more than.

For example, if the remainder polynomial ri(x) is expressed by ri(x)=Σcⱼx^{j} (the range of the sum is j=0 to di−1), remainders ri may be expressed by
ri=Σq^{j}cⱼ(the range of the sum is j=0 to di−1)

If all irreducible polynomials are set to linear monic irreducible polynomials as in the above case, the remainder polynomials ri(x) obtained by the remainder polynomial calculators 122-i are all zero-order values, i.e., all integers. Therefore, the ri(x) values are converted into nonnegative integers under a predetermined rule. For example, when the elements of Fq are represented by the elements of Z_{q-1}, ri(x) may be set to ri (ri(x)=ri). In other words, the remainder polynomials ri(x) obtained by the remainder polynomial calculators 122-i may be output as remainders ri, without any changes.

Further, if only prime ideals of the minimum norm are set as divisor bases, and if only linear monic irreducible polynomials included in a polynomial ring on a finite field are set as divisor bases, the remainder polynomials ri(x) obtained by the remainder polynomial calculators 122-i may be output as remainders ri, without any changes, and no remainder calculators 123-i may be used.

As stated above, the string {r1, r2, . . . , rN} of the remainders ri output from all the remainder calculators 123-i is the previously-mentioned redundant residue representation.

For instance, in the above-described example, if ri=ri(x), the redundant residue representation {r1, r2, r3} corresponding to each identification information item u is as follows:
u=0 . . . r1=0, r2=0, r3=0
u=1 . . . r1=1, r2=1, r3=1
u=2 . . . r1=2, r2=2, r3=2
u=3 . . . r1=0, r2=1, r3=2
u=4 . . . r1=1, r2=2, r3=0
u=5 . . . r1=2, r2=0, r3=1
u=6 . . . r1=0, r2=2, r3=1
u=7 . . . r1=1, r2=0, r3=2
u=8 . . . r1=2, r2=1, r3=0

Component code generation and collusion-secure code generation will now be described.

Each component code generator 124-i (i=1 to N) generates a component code W(i) based on the corresponding remainder ri. Specifically, each component code generator 124-i (i=1 to N) generates a component code W(i) formed of the aforementioned Γ0(q, t) code that represents the remainder ri acquired by the remainder calculator 123-i (i=1 to N) based on the element number q of the finite field Fq stored in the first parameter storage 126 and the coder parameter t stored in the second parameter storage 127.

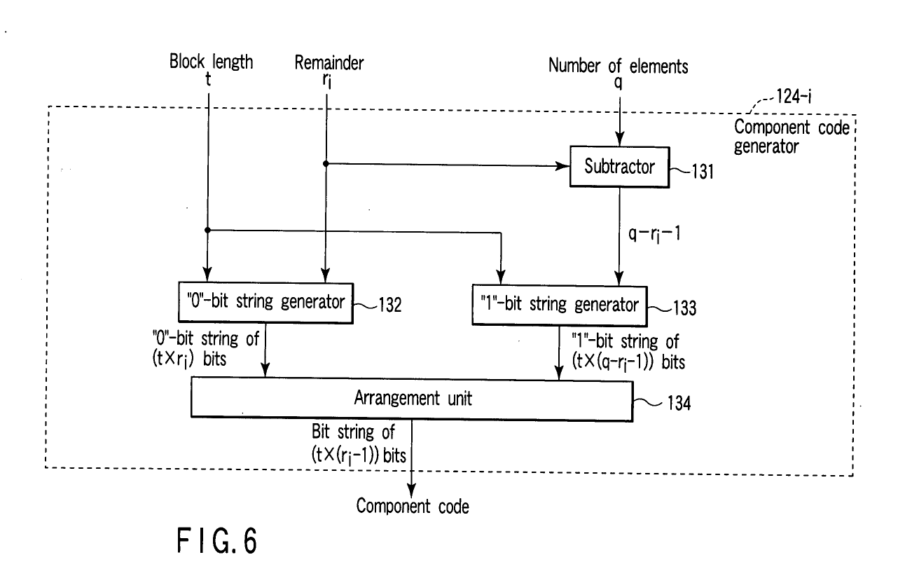

FIG. 6 shows the configuration of one (124-i) of the component code generators 124-1 to 124-N. Assuming that the block length is t, the remainder is ri, and the number of blocks (the number of the elements of the finite field Fq) is q, a subtractor 131 calculates q−ri−1. A “0”-bit string generator 132 generates a “0” string formed of (t×ri) bits based on the code parameter t and remainder ri. A “1”-bit string generator 133 generates a “1” string formed of {t×(q−ri−1)} bits based on the code parameter t and the output (q−ri−1) of the subtractor 131. These “0” string and “1” string are arranged in line by an arrangement unit 134, thereby generating, as a component code W(i) of a c-secure CRT code, a bit string formed of a series of (t×(q−1)) bits.

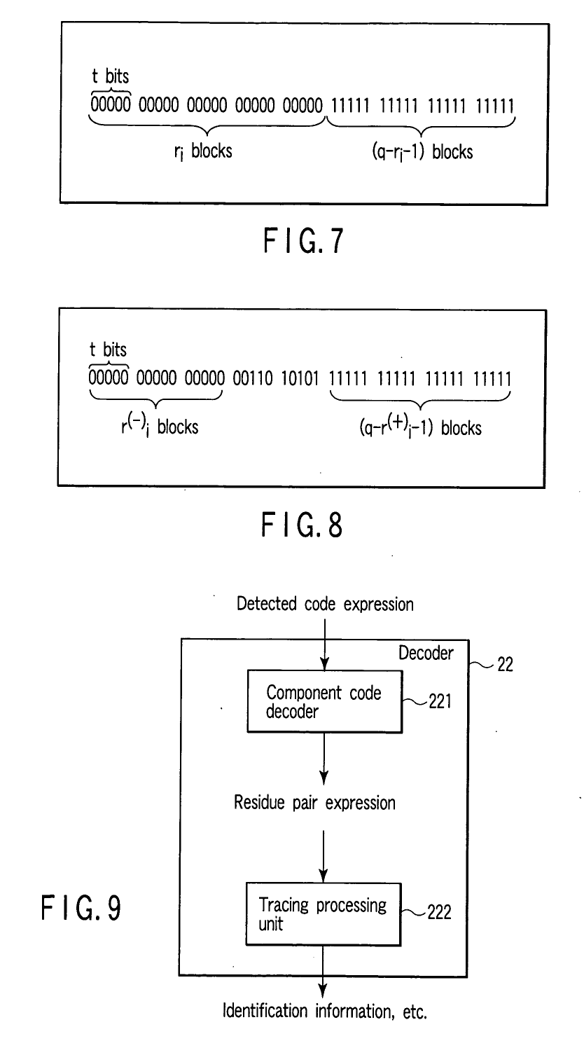

FIG. 7 shows an example of the component code W(i). The shown component code W(i) is formed of a number (q−1) of blocks, each block being of t-bits. A number ri of first blocks contain data of 0, and a number (q−ri−1) of next blocks contain data of 1. In the case of FIG. 7, t is set to 5.

The code arrangement unit 125 arranges, in series, the component codes W(1), W(2), . . . , W(N) generated by the component code generators 124-1, 124-2, . . . , 124-N, thereby generating a collusion-secure code W as digital watermark information.

In the above case, if t=5 and q=3, a collusion-secure code W=W(1)∥W(2)∥W(3) for each identification information item (u=0 to 8) have, for example the following data structure (for easy understanding, the component codes are separate from each other):
u=0 . . . W=1111111111 1111111111 1111111111
u=1 . . . W=0000011111 0000011111 0000011111
u=2 . . . W=0000000000 0000000000 0000000000
u=3 . . . W=1111111111 0000011111 0000000000
u=4 . . . W=0000011111 0000000000 1111111111
u=5 . . . W=0000000000 1111111111 0000011111
u=6 . . . W=1111111111 0000000000 0000011111
u=7 . . . W=0000011111 1111111111 0000000000
u=8 . . . W=0000000000 0000011111 1111111111

For comparison, collusion-secure code examples will be shown which are used when divisor bases are selected from the ring of rational integers.

If divisor bases are {3, 5, 7}, the following redundant residue representation A (1)=u mod 3, A(2)=u mod 5 and A(3)=u mod 7 is obtained for each identification information item u (u=0 to 8):
u=0 . . . A(1)=0, A(2)=0, A(3)=0
u=1 . . . A(1)=1, A(2)=1, A(3)=1
u=2 . . . A(1)=2, A(2)=2, A(3)=2
u=3 . . . A(1)=0, A(2)=3, A(3)=3
u=4 . . . A(1)=1, A(2)=4, A(3)=4
u=5 . . . A(1)=2, A(2)=0, A(3)=5
u=6 . . . A(1)=0, A(2)=1, A(3)=6
u=7 . . . A(1)=1, A(2)=2, A(3)=0
u=8 . . . A(1)=2, A(2)=3, A(3)=1

Further, in the above example, if t=5, the following collusion-secure code examples are obtained from the redundant residue representations {A(1), A(2), A(3)} corresponding to the respective identification information items u (u=0 to 8) (for easy understanding, the component codes are separate from each other):
u=0: 1111111111 11111111111111111111 111111111111111111111111111111
u=1: 0000011111 00000111111111111111 000001111111111111111111111111
u=2: 0000000000 00000000001111111111 000000000011111111111111111111
u=3: 1111111111 00000000000000011111 000000000000000111111111111111
u=4: 0000011111 00000000000000000000 000000000000000000001111111111
u=5: 0000000000 11111111111111111111 000000000000000000000000011111
u=6: 1111111111 00000111111111111111 000000000000000000000000000000
u=7: 0000011111 00000000001111111111 111111111111111111111111111111
u=8: 0000000000 00000000000000011111 000001111111111111111111111111

The digital watermark analysis apparatus 2 will be described in detail.

Firstly, a collusion attack will be explained using the above case as an example.

For example, assume that identification information is a user ID, and a content acquired by a user with a user ID of 7 has the following collusion-secure code embedded therein:
0000011111 1111111111 0000000000

Further, assume that a content acquired by a user with a user ID of 8 has the following collusion-secure code embedded therein:
0000000000 0000011111 1111111111

In the above 30 bits, the 6th to 15th bits and the 21st to 30th bits from the left differ between the contents owned by the users of the user IDs of 7 and 8. From this, it is understood that the different bits are parts of the identification information (i.e., parts of the collusion-secure codes). Therefore, part of the 6th to 15th bits and the 21st to 30th bits from the left may be altered, for example, as follows:
0000010101 0101011111 0101010101

At this time, in the digital watermark analysis apparatus 2 of the embodiment, firstly, the code extraction unit 21 extracts, from the copies of the target content, embedded codes (embedded collusion-secure codes or codes obtained by altering the collusion-secure codes).

Subsequently, the decoder 22 executes a tracing algorithm on the extracted codes.

The outline of the tracing algorithm will be described here.

Firstly, a description will be given of a residue pair representation.

In the tracing algorithm, each of the component codes (in the above case, three component codes) of the extracted code (generated collusion-secure code or collusion-secure code subjected to a collusion attack) is divided into blocks, each block consisting of a number t of bits. The boundaries of the blocks, which include blocks formed of only “0” bits, blocks formed of only “1” bits and blocks formed of “0” and “1” bits, are digitized. Specifically, as shown in, for example, FIG. 8, concerning an i-th component code W(i), the number of blocks counted from the left until a block other than the blocks containing only “0” bits is detected for the first time is set to r⁽⁻⁾ᵢ, and the number of blocks counted from the right until a block other than the blocks containing only “1” bits is detected for the first time is set to q−r⁽⁺⁾ᵢ−1. The values of r⁽⁻⁾ᵢ and r⁽⁺⁾ᵢ are obtained.

If the i-th component code W(i) is formed of only data “0”, r⁽⁻⁾ᵢ=r⁽⁺⁾ᵢ=q−1.

Further, if the i-th component code W(i) is formed of only data “1”, r⁽⁻⁾ᵢ=r⁽⁺⁾ᵢ=0.

If there is no boundary between the blocks containing only “0” bits and the blocks containing “1” bits, r⁽⁻⁾ᵢ=0.

Further, if there is no boundary between the blocks containing only “1” bits and the blocks containing “0” bits, r⁽⁺⁾ᵢ=q−1.

Thus, a pair of position information items r⁽⁻⁾ᵢ and r⁽⁺⁾ᵢ can be acquired from a single component code W(i). The pair of r⁽⁻⁾ᵢ and r⁽⁺⁾ᵢ will hereinafter be referred to as a “(the i-th) residue pair”. The set (r⁽⁻⁾₁, r⁽⁺⁾₁, r⁽⁻⁾₂, r⁽⁺⁾₂, . . . , r⁽⁻⁾_{N}, r⁽⁺⁾_{N}) of all residue pairs obtained from all component codes W(i) will hereinafter be referred to as a “residue pair representation”.

For instance, in the collusion-secure code,
0000011111 1111111111 0000000000,
   included in the above-described examples and corresponding to identification information item u=7, r⁽⁻⁾₁=r⁽⁺⁾₁=1, r⁽⁻⁾₂=r⁽⁺⁾₂=0, and r⁽⁻⁾₃=r⁽⁺⁾₃=2.

Similarly, in the collusion-secure code,
0000000000 0000011111 1111111111
   corresponding to identification information item u=8, r⁽⁻⁾₁=r⁽⁺⁾₁=2, r⁽⁻⁾₂=r⁽⁺⁾₂=1, and r⁽⁻⁾₃=r⁽⁺⁾₃=0.

Further, in the collusion-secure code example subjected to a collusion attack,
0000010101 0101011111 0101010101,
   r⁽⁻⁾₁=1, r⁽⁺⁾₁=2, r⁽⁻⁾₂=0, r⁽⁺⁾₂=1, r⁽⁻⁾₃=0 and r⁽⁺⁾₃=2.

As is understood from the above, a residue pair representation acquired from a correct collusion-secure code corresponds to the redundant residue representation. On the other hand, a residue pair representation acquired from a collusion-secure code subjected to a collusion attack does not correspond to a residue pair representation corresponding to any identification information.

In the tracing algorithm, each component code of a detected code is inspected, and if there is a component code in which a block containing “1” or “0” bits less than a predetermined number t of bits (in the above case, t=5) exists, it is determined that the code is subjected to a collusion attack. Further, in this case, (assuming that the number of people responsible for a collusion attack is not more than an allowable number c), one or more identification information items corresponding to one or more collusion-secure codes that seem to have been embedded in copies subjected to a collusion attack are obtained based on all the residue pairs acquired from all the component codes W(i), i.e., the residue pair representation (r⁽⁻⁾ᵢ, r⁽⁺⁾ᵢ (i=1 to N)). The one or more identification information items can be uses as one or more identification information items (e.g., user IDs) corresponding to the people responsible for a collusion attack.

As is understood from the above-described comparison, concerning a component code W(i) corresponding to each remainder ri of a redundant residue representation, the different data portions of a plurality of copies are always detected as blocks containing a number t of continuous bits (accordingly, if these portions are altered by a collusion attack, they each contain both “0” and “1” bits).

Further, in a certain component code (i), the left position and/or right position, i.e., r⁽⁻⁾₁ and/or r⁽⁺⁾₁, of a block, which contains “1” or “0” bits less than the number t of bits, always corresponds to the position in a corresponding component code of a collusion-secure code embedded in any of copies used for a collusion attack, at which “0” bits and “1” bits are separate. In other words, r⁽⁻⁾ᵢ and/or r⁽⁺⁾ᵢ correspond to the remainder ri of a redundant residue representation related to the copies. If the corresponding component code contains only “1” bits, its left position corresponds to position at which “0” bits and “1” bits are separate Further, if the corresponding component code contains only “0” bits, its right position corresponds to position at which “0” bits and “1” bits are separate Furthermore, if the remainders ri related to the copies subjected to a collusion attack are all equal to each other, it is considered that the certain component code (i) is not altered. In this case, r⁽⁻⁾ᵢ=r⁽⁺⁾ᵢ=ri. Such information is acquired in units of component codes W(i). By analyzing the information, r⁽⁻⁾₁, r⁽⁺⁾₁, r⁽⁻⁾₂, r⁽⁺⁾₂, . . . , r⁽⁻⁾_{N}, r⁽⁺⁾_{N}, identification information corresponding to a collusion-secure code that seem to have been embedded in copies used for a collusion attack can be specified as identification information corresponding to the people responsible for a collusion attack.

The decoder 22 incorporated in the digital watermark analysis apparatus 2 of the embodiment will be described in detail.

FIG. 9 is a block diagram illustrating a configuration example of the decoder 22 incorporated in the digital watermark analysis apparatus of the embodiment.

As shown in FIG. 9, the decoder 22 includes a component code decoder 221 for receiving the code (embedded collusion-secure code, or a code obtained by altering the collusion-secure code) read from a target content, and outputting residue pairs acquired from each component code W(i), i.e., a residue pair representation r⁽⁻⁾ᵢ, r⁽⁺⁾ᵢ (i=1 to N). The decoder 22 also includes a tracing processing unit 222 for performing tracing processing related to identification information, based on the residue pair representation r⁽⁻⁾ᵢ, r⁽⁺⁾ᵢ (i=1 to N), and outputting tracing information indicating the tracing result.

Firstly, the component code decoder 221 will be described.

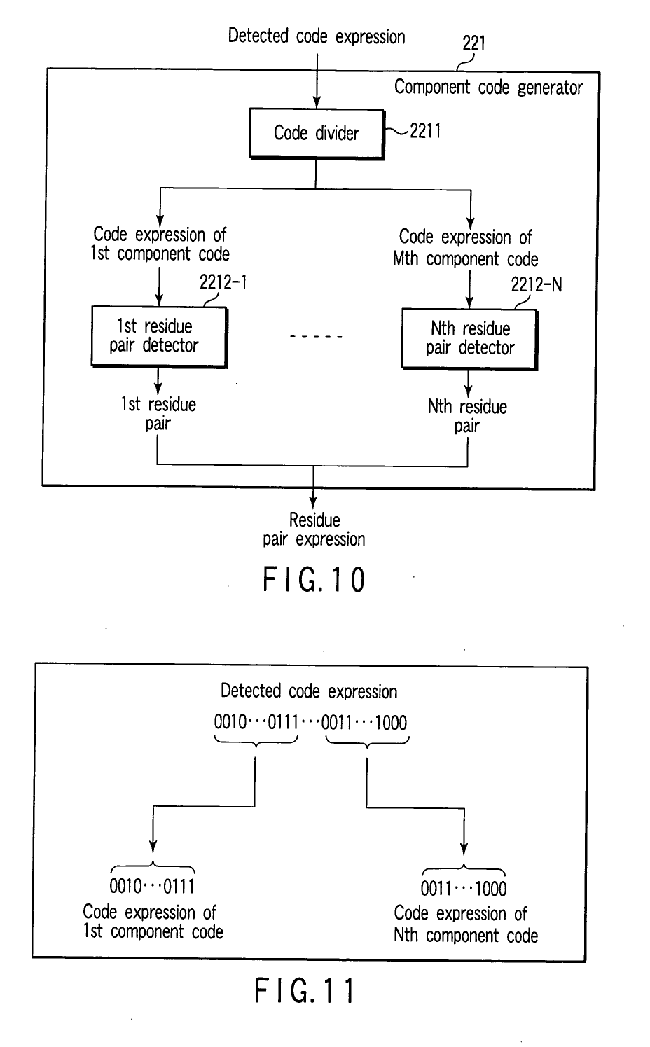

FIG. 10 shows a configuration example of the component code decoder 221.

As seen from FIG. 10, the component code decoder 221 comprises a code divider 2211, a number N of residue pair detectors 2212-1 to 2212-N corresponding to the component codes W(1) to W(N).

FIG. 11 shows a process example performed by the code divider 2211.

As shown in FIG. 11, the code divider 2211 receives a detected code, and divides it into component codes in accordance with the component code length. In Γ0(q, t) code, the code length of the component code W(i) is ((q−1)×t) bits. The values q, t and/or (q−1)×t may be prestored or input when necessary.

Assume that the above-mentioned code,
0000010101 0101011111 0101010101,
   obtained by subjecting a collusion-secure code to a collusion attack is detected. In this case, t=5 and q=3, therefore (q−1)×t=10. This code is divided in units of ten bits, thereby acquiring the following:
Component code W(1)=0000010101;
Component code W(2)=0101011111; and
Component code W(3)=0101010101

These component codes W(1) to W(N) are supplied to the residue pair detectors 2211-1 to 2211-N, respectively.

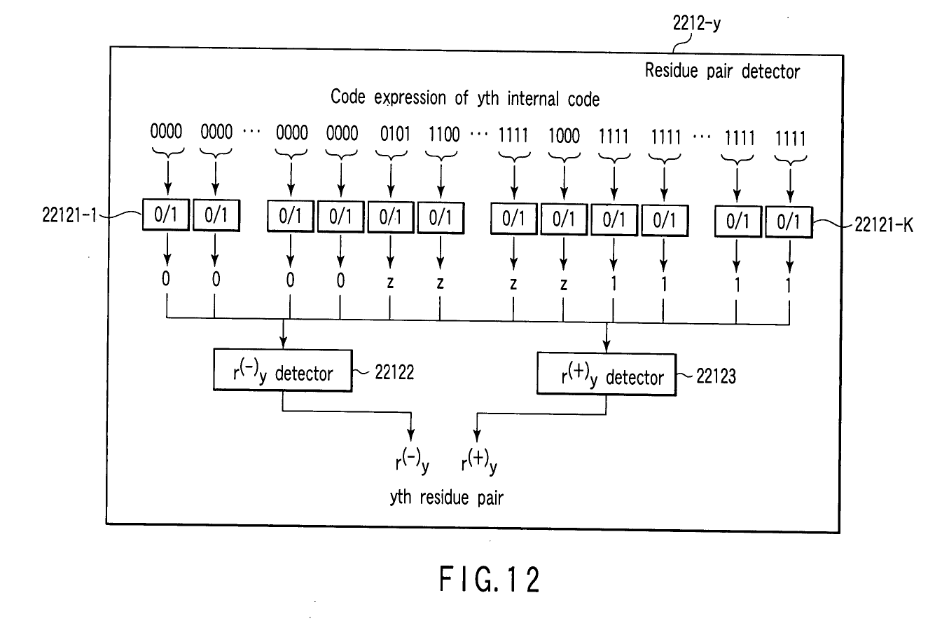

FIG. 12 shows a configuration example of a y-th residue pair detector 2211-y corresponding to a y-th component code W(y) obtained from the component code decoder 221. Although only the y-th residue pair detector 2211-y is shown, the other residue pair detectors 2211 have the same configuration.

As seen from FIG. 12, the y-th residue pair detector 2211-y includes a number K (K=q−1) of determination units 22121-1 to 22121-K corresponding to a number K of blocks (containing a number t of bits) included in the y-th component code W(y), a first boundary position detector 22122 for detecting a boundary position r⁽⁻⁾_{y}, and a second boundary position detector 22123 for detecting a boundary position r⁽⁺⁾_{y}.

The determination units 22121-1 to 22121-K each determine whether the number t of bits contained in a corresponding block are all “0” bits, all “1” bits, or “0” and “1” bits.

The first boundary position detector 22122 refers to the outputs of the determination units 22121-1 to 22121-K, beginning from the determination unit 22121-1, thereby obtaining the aforementioned boundary position r⁽⁻⁾_{y}.

Similarly, the second boundary position detector 22123 refers to the outputs of the determination units 22121-1 to 22121-K, beginning from the determination unit 22121-K, thereby obtaining the aforementioned boundary position r⁽⁺⁾_{y}.

The detected pair of r⁽⁻⁾_{y} and r⁽⁺⁾_{y} is the y-th residue pair.

For example, in the above-described example, W(1), W(2) and W(3) are supplied to the first to third residue pair detectors 2212-1, 2212-2 and 2212-3, respectively, and the following first to third residue pairs are output from the first to third residue pair detectors 2212-1, 2212-2 and 2212-3, respectively:
First residue pair={r⁽⁻⁾₁, r⁽⁺⁾₁}={1, 2}
Second residue pair={r⁽⁻⁾₂, r⁽⁺⁾₂}×{0, 1}
Third residue pair={r⁽⁻⁾₃, r⁽⁺⁾₃}={0, 2}

The set of the thus-obtained first residue pair (r⁽⁻⁾₁, r⁽⁺⁾₁) to the N-th residue pair (r⁽⁻⁾_{N}, r⁽⁺⁾_{N}), i.e., the residue pair representation, is supplied to the tracing processing unit 222.

The tracing processing unit 222 incorporated in the decoder 22 of the digital watermark analysis apparatus 2 of the embodiment will be described.

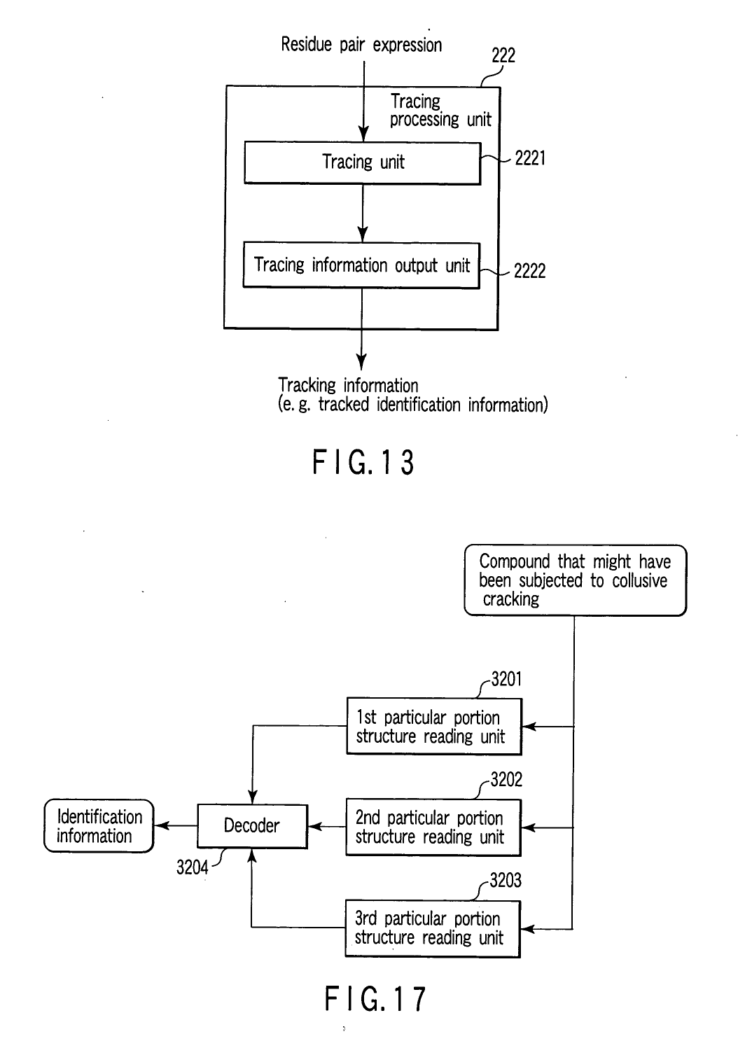

FIG. 13 shows a configuration example of the tracing processing unit 222.

As seen from FIG. 13, the tracing processing unit 222 includes a tracing unit 2221 and tracing information output unit 2222.

The tracing unit 2221 acquires, using a predetermined tracing algorithm, the residue pair representation, r⁽⁻⁾₁, r⁽⁺⁾₁, r⁽⁻⁾₂, r⁽⁺⁾₂, . . . , r⁽⁻⁾_{N}, r⁽⁺⁾_{N}, obtained by the component code decoder 221. Based on the acquired residue pair representation, the tracing unit 2221 determines or estimates all or part of the identification information corresponding to a plurality of copies used for a collusion attack, if there is any a collusion attack. If there is no a collusion attack, identification information corresponding to the residue pair representation=redundant residue representation may be acquired.

As described above, from the code,
0000010101 0101011111 0101010101,
   obtained by subjecting a collusion-secure code to a collusion attack, the following residue pairs are obtained:
First residue pair={r⁽⁻⁾₁, r⁽⁺⁾₁}={1, 2}
Second residue pair={r⁽⁻⁾₂, r⁽⁺⁾₂}={0, 1}
Third residue pair={r⁽⁻⁾₃, r⁽⁺⁾₃}={0, 2}

On the other hand, the redundant residue representation corresponding to identification information u (u=0 to 8) is:
u=0 . . . {0, 0, 0}
u=1 . . . {1, 2, 1}
u=2 . . . {2, 2, 2}
u=3 . . . {0, 1, 2}
u=4 . . . {1, 2, 0}
u=5 . . . {2, 0, 1}
u=6 . . . {0, 2, 1}
u=7 . . . {1, 0, 2}
u=8 . . . {2, 1, 0}

From the above, identification information=7 and identification information=8 are estimated.

Any tracing algorithm may be used.

A probabilistic method or deterministic method is regarded as a typical type of algorithm.

In the probabilistic method, basically, if a predetermined number of residue pairs selected from a residue pair representation detected from a target content correspond to certain identification information, they are estimated as identification information corresponding to copies used for a collusion attack. The predetermined number is determined based on, for example, an erroneous recognition ratio at which the redundant residue representation of identification information unrelated to a collusion attack is unintentionally estimated as the target identification information. To minimize the erroneous recognition ratio, the predetermined number is set to a higher value, for example.

In the deterministic method, basically, part or all identification information corresponding to copies used for a collusion attack is determined without errors based on a residue pair representation detected from a target content (no identification information may be determined). To eliminate a tracing disabled case zero or minimize the number of tracing disabled cases, it is advisable to increase the number N of elements of a redundant residue representation, assuming that the value range of identification information is constant.

The tracing algorithm disclosed in Jpn. Pat. Appln. KOKAI Publication No. 2001-285623, 2002-165081, 2003-163800 or 2003-224555 may be utilized.

Further, information required for a tracing algorithm used may be input from the outside when this algorithm is executed, or may be prestored. This information is, for example, the value range of used identification information, the maximum number c of people responsible for a collusion attack, a redundant residue representation corresponding each identification information item, or a residue pair representation estimated to be acquired when collusion cracking is performed by a group of particular identification information items.

If a redundant residue representation corresponding to each identification information item is needed, it may be acquired each time the tracing algorithm is executed, using the polynomial generator 120, irreducible polynomial storages 121-1 to 121-N, remainder polynomial calculators 122-1 to 122-N and remainder calculators 123-1 to 123-N shown in FIG. 5. The once-calculated values may be stored.

A method may be employed, which differs from the method in which if there is a collusion attack, all or some of identification information items corresponding to copies used for a collusion attack are determined or estimated, based on a detected residue pair representation and a redundant residue representation corresponding to each identification information item.

For instance, a method may be used, wherein a redundant residue polynomial representation is obtained in which each remainder r⁽⁻⁾ᵢ or r⁽⁺⁾ᵢ of each residue pair in a residue pair representation is replaced with the corresponding remainder polynomial. Further, in this method, all or some of identification information items corresponding to copies used for a collusion attack are determined or estimated, based on the resultant redundant residue polynomial representation and a standard remainder polynomial representation corresponding to each identification information item. The standard remainder polynomial representation is obtained by replacing each remainder of the redundant residue representation with the corresponding remainder polynomial.

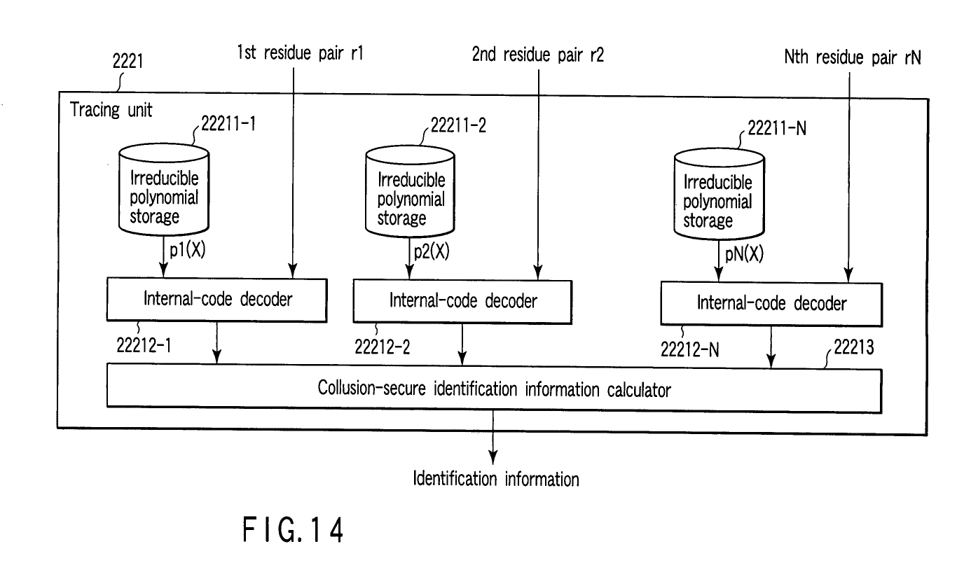

This method can be realized by, for example, a decoder disclosed in Document “Neal R. Wagner, “Fingerprinting,” Proceedings of the 1983 Symposium on Security and Privacy, Oakland, Calif., U.S.A., 25-27 Apr. 1983, Technical Committee on Security & Privacy, IEEE Computer Society, 18-22, 1983.”. This decoder corresponds to the configuration example, shown in FIG. 14, of the tracing unit 2221 of the tracing processing unit 222 of the decoder 22. As seen from FIG. 14, the tracing processing unit 222 comprises a number N of irreducible polynomial storages 22211-1 to 22211-N, a number N of internal-code decoders 22212-1 to 22212-N and a collusion attack identification information calculator 22213.

Also in this case, each irreducible polynomial storage 121-i (i=1 to N) stores an i-th prim ideal which is one of the prime ideals that are pairwise relatively prime. More specifically, each irreducible polynomial storage 121-i stores a pre-selected i-th irreducible polynomial pi(x) included in the irreducible polynomials of a polynomial ring on a finite field Fq (={0, 1, . . . , q−1}). The irreducible polynomial pi(x) is supplied to each internal-code decoder 22212-i (i=1 to N).

Each internal-code decoder 22212-i (i=1 to N) acquires a residue pair of the Dedekind ring R, which corresponds to the remainders r⁽⁻⁾ᵢ and r⁽⁺⁾ᵢ. If a polynomial ring on a finite field is used as a Dedekind ring, as in the above embodiment, each internal-code decoder 22212-i (i=1 to N) performs an operation reverse to the operation performed by the remainder calculator 123-i in FIG. 5. As a result, each decoder 22212-i acquires a remainder polynomial pair formed of a remainder polynomial corresponding to the remainder r⁽⁻⁾ᵢ and a remainder polynomial corresponding to the remainder r⁽⁺⁾ᵢ.

Based on the set of i-th to N-th remainder polynomial pairs (a remainder polynomial representation), the collusion attack identification information calculator 22213 determines or estimates whether a collusion attack has occurred, or determines or estimates all or some of the identification information items corresponding to copies used for a collusion attack, if there is any a collusion attack. This process is basically the same as the process in which whether a collusion attack has occurred is determined or estimated on the basis of the remainder polynomial representation, or all or some of the identification information items corresponding to copies used for a collusion attack are determined or estimated on the basis of the representation. For example, the collusion attack identification information calculator 22213 acquires an identification information polynomial corresponding to each identification information, confirms whether the i-th remainder polynomial obtained by dividing the identification information polynomial by the i-th irreducible polynomial is identical to one of the i-th remainder polynomial pair of the remainder polynomial representation. If the number of the identical cases is not less than a predetermined value, the identification information is determined to correspond to the copies used for a collusion attack.

For example, in the above-mentioned case, the following were acquired from the code,
0000010101 0101011111 0101010101,
   obtained by subjecting a collusion-secure code to a collusion attack:
First residue pair={r⁽⁻⁾₁, r⁽⁺⁾₁}={1, 2}
Second residue pair={r⁽⁻⁾₂, r⁽⁺⁾₂}={0, 1}
Third residue pair={r⁽⁻⁾₃, r⁽⁺⁾₃}={0, 2}

In this example, the following can be acquired from remainder ri=remainder polynomial ri(x):
First remainder polynomial pair={1, 2}
Second remainder polynomial pair={0, 1}
Third remainder polynomial pair={0, 2}

Accordingly, identification information=7 and identification information=8 are acquired.

It is a matter of course that various types of tracing algorithm other than the above one can be utilized.

The tracing results obtained by the tracing processing unit 222 are supplied to the tracing information output unit 2222.

The tracing information output unit 2222 outputs tracing information indicating the tracing results of the tracing processing unit 222.

The tracing information varies between different types of tracing algorithm. For example, the tracing information includes information indicating all or some of the identification information items corresponding to copies that might have been used for a collusion attack, if a collusion attack is detected. The cracking information also includes information indicating that no identification information corresponding to copies that might have been used for a collusion attack has been determined, although a collusion attack is detected. The tracing information further includes information indicating that no a collusion attack has occurred (or indicating identification information detected and the message that no a collusion attack has occurred. Further, the tracing information may include information indicating a residue pair representation detected, or information indicating a redundant residue representation corresponding to the detected identification information. Furthermore, if identification information is not a user ID, a user ID corresponding to identification information may be detected and be included in the tracing information instead of identification information or as well as identification information.

As described above, in the embodiment, in a c-secure CRT code based on prime ideals on a Dedekind ring (e.g., irreducible polynomials included in a polynomial ring on a finite ring), the code length of the c-secure CRT code can be shortened by limiting the norms of prime ideals (e.g., irreducible polynomials) as divisor bases. For limiting the norms, for example, prime ideals having the same norm are selected, or irreducible polynomials having the same order (e.g., the first order) are selected. This enables a code to be embedded in an object, such as digital content, which is too small to have the code embedded by a conventional technique.

The hardware and software configurations employed in the embodiment will be described.

The digital watermark analysis apparatus of the embodiment can be realized by hardware or software (a program for instructing a computer to execute a predetermined means or function, or to enable the computer to function as predetermined means). To realize the digital watermark analysis apparatus in the form of software, the program can be acquired from a recording medium or communication medium. These can be said of the digital watermark embedding apparatus.

If the digital watermark embedding or analysis apparatus is realized by hardware, they can be formed as a semiconductor device.

Also, to construct the digital watermark embedding or analysis apparatus of the invention, or to create a digital watermark analysis program, if there are blocks or modules of the same configuration (or a commonly usable configuration), they may be prepared individually. Alternatively, a single or an appropriate number of blocks or modules of the same configuration (or a commonly usable configuration) may be commonly used in various portions of algorithm. The same can be said of the construction of the digital watermark embedding apparatus or program. Moreover, to construct a system including the digital watermark embedding and analysis apparatuses, or including digital watermark embedding and analysis programs, a single or an appropriate number of blocks or modules of the same configuration (or a commonly usable configuration) may be commonly used in various portions of algorithm between the digital watermark embedding apparatus (or program) and digital watermark analysis apparatus (or program).

To construct the digital watermark embedding or analysis apparatus using software, if a microprocessor is used to enable parallel processing, the processing speed can be increased.

The above-described configuration can be realized not only as a part of an apparatus, but also as an independent apparatus itself. For instance, the decoder 22 of the digital watermark analysis apparatus is realized as an inseparable part of the apparatus, or as a separate component or module included in the apparatus, or as an independent decoder apparatus.

The watermark technique related to digital watermarks is also applicable to information or material, the identity, quality or economical value of which does not change even if the information or material is partially varied. Accordingly, the present invention is also applicable to such information or material.

For example, the generation means or detection means employed in the digital watermark embedding and analysis apparatuses for generating a collusion-secure code is also usable for identifying organic compounds or chemical substances formed in industrial environments, or for tracing their origins. High polymers, such as DNA, RNA and proteins, have redundancy that enables a code to be embedded therein.

A description will now be given of a case where the present invention is used as a watermark technique for embedding individual identification information items (e.g., user IDs, manufacturer IDs, distributor IDs, transaction IDs, their combinations, etc.) into copies of a compound to enable their origins to be detected.

Compounds are formed of substances, such as atoms, molecules, groups. DNA or RNA, for example, has a predetermined amino-acid arrangement. If part of the amino-acid arrangement is replaced with another amino acid, this can be regarded as information expression. There is digital content, the identity or economical value of which does not change even if part of the content is varied. Likewise, there is a chemical substance, the properties or functions (e.g., an effect, side effect, in another aspect, the economical value) of which do not change even if its composition is varied. By changing the composition within an allowable range, information can be embedded into copies of the chemical substance.

When the watermark technique of the present invention is applied to a compound, a watermark embedding apparatus for the compound is obtained by replacing, with a device for varying the composition of a predetermined portion of the compound, the configuration of the watermark embedding apparatus that varies a predetermined bit portion of digital content. (In this case, the code generator can be used unchanged.) Similarly, a watermark analysis apparatus for the compound is obtained by replacing, with a device for analyzing the composition of a predetermined portion of the compound to detect watermark information, the configuration of the watermark analysis apparatus that detects information for reading a bit value of a predetermined bit portion of digital content to detect watermark information. (In this case, the decoder can be used unchanged.) In other words, the watermark technique for compounds is the same in principle as that for digital contents, except for the device as an interface for the compounds.

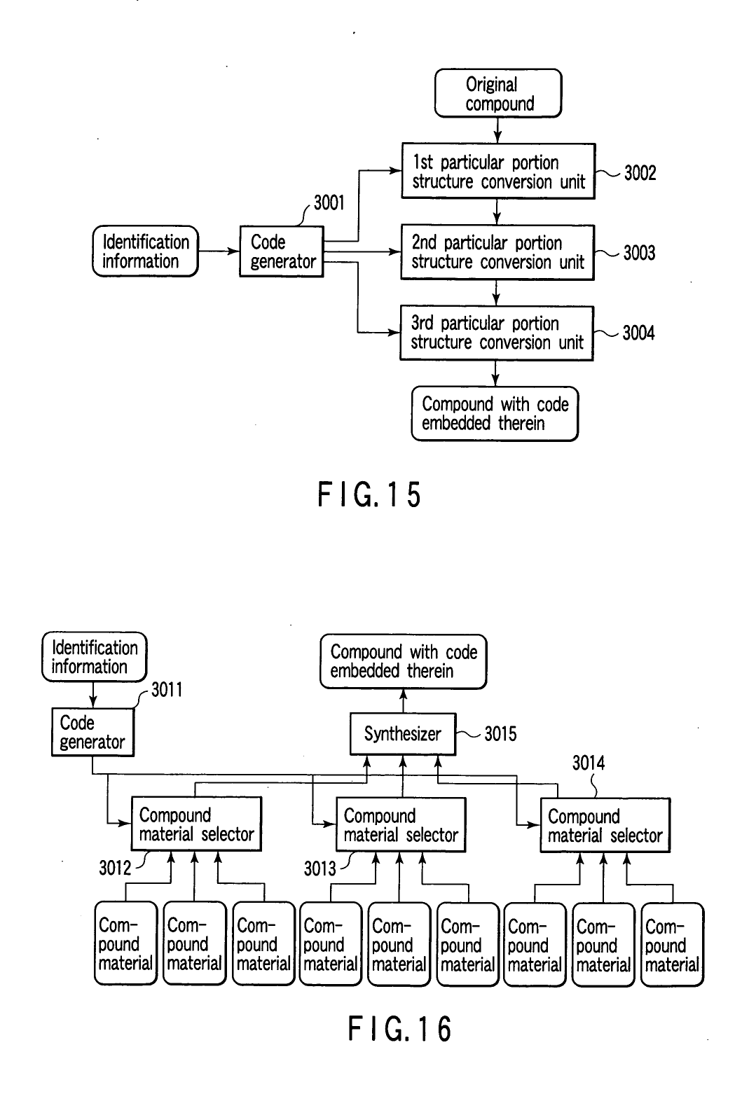

FIG. 15 shows a configuration example of the watermark embedding apparatus for compounds.

A code generator 3001 receives identification information to be embedded into a compound, and generates a collusion-secure code (this generator may have the same structure as the code generator 11 shown in FIG. 2).

Particular portion structure conversion units 3002 to 3004 convert the structure of a compound in accordance with each bit or each bit set of a collusion-secure code. The particular portion structure conversion unit 3002 processes a particular portion 1 of an original compound. The particular portion structure conversion unit 3003 processes a particular portion 2 of the compound having the particular portion 1 processed. The particular portion structure conversion unit 3004 processes a particular portion 3 of the compound having the particular portions 1 and 2 processed. Although the case of FIG. 15 employs three structure conversion units, the number of structure conversion units is not limited to three.

The conversion of the structure of a compound means the conversion of a compound into a compound of another structure with its properties or functions suitable for the purpose of use unchanged, and without a new harmful effect or side effect. Further, if the compound is not a pure compound but a mixture, the above conversion may mean the conversion of the composition of the compound.

FIG. 16 shows another configuration example of the watermark embedding apparatus for compounds.

The configuration example of FIG. 15 converts the structure of an already synthesized compound, while that of FIG. 16 embeds a code into a compound when the compound is synthesized.

In FIG. 6, a code generator 3011 acquires identification information to be embedded into a compound, and generates a collusion-secure code (this generator may have the same configuration as the code generator 11 of FIG. 2).

In this case, a compound material is prepared for each bit or each set of bits of the collusion-secure code in accordance with the value of each bit or each bit set. Compound material selectors 3012 to 3014 select a compound material for each bit or each bit set of the collusion-secure code in accordance with the value of each bit or each bit set. Although the case of FIG. 16 employs three compound material selectors, the number of compound material selectors is not limited to three.

A synthesizer 3015 synthesizes the compound materials selected by the compound material selectors 3012 to 3014, thereby generating a desired code-embedded compound.

The way of a collusion attack against compounds is basically the same as that of a collusion attack against digital contents. For example, in a collusion attack against a compound, the structures of a plurality of compounds, in which different identification information items (such as user IDs, manufacturer IDs, distributor IDs or transaction IDs) are embedded, are compared. After that, the structures of portions of the compounds, which are determined different from the comparison, are altered.

FIG. 17 shows a configuration example of the watermark analysis apparatus for compounds.

In FIG. 17, particular portion structure reading units 3201 to 3203 correspond to the particular portion structure conversion units 3002 to 3004 in FIG. 15, or to the compound material selectors 3012 to 3014 in FIG. 16. The particular portion structure reading units 3201 to 3203 read the structure of a particular portion of a compound, and outputs the read structure as information in the form of a bit or a set of bits.

A decoder 3204 executes tracing algorithm based on the information to determine whether a collusion attack has occurred, and determine a user ID corresponding to a collusion-secure code embedded in each of the copies that might have been used for a collusion attack (this decoder may have the same configuration as the decoder 22 shown in FIG. 3).

Techniques useable as the compound structure conversion means and structure reading means employed in the present invention will be described. Techniques for converting and reading DNA structures will be described as examples.

The acquisition of a DNA base sequence is called sequencing. Shotgun method, primer walk method, nested deletion method, etc. are known as sequencing methods. These methods are all DNA cloning methods. Reagents and devices for sequencing are disclosed in, for example, “Cloning and Sequence” by Kaku Watanabe and Masahiro Sugiura, published 1989 by Nohson Bunka Corporation, and “Genom Science” by Yoshiyuki Sakaki, published 1999 by Syoritsu Publishing Company.

In the case of DNA, the structure conversion can be carried out by a gene transfer method used to transfer a new gene. Gene transfer methods include chemical methods, such as phosphoric acid calcium deposition, dextran method and lipofection, an electrical punching method and microinjection, etc. Concerning these methods, see, for example, “Molecular Cellular Technology” by Nobuyuki Haga, published 2000 by Corona Corporation.

In the above description, tracing of a compound or chemical substance has been explained as an example of tracing other than the tracing of copies of digital content.

Assuming that such a to-be-tracked object as the above is called an “object”, the present invention is also applicable to objects other than a compound or chemical substance. In the embodiment, a description has been given of digital content as an example of an object having no physical substance (or an object to be exchanged via a physical substance). Although the embodiment employs a digital watermark technique as a technique for embedding, into digital content, a collusion-secure code corresponding to identification information, it can employ other techniques. Further, in the embodiment, DNA, RNA or proteins are employed as examples of physical objects. In the embodiment, a technique for replacing part of an amino acid arrangement has been exemplified as a technique for writing a collusion-secure code corresponding to identification information into DNA, RNA or proteins. However, also in this case, an electronic information processing system can write identification information or a collusion-secure code into DNA, RNA or proteins, if a technique for interfacing such an object is changed. In principle, the same processing can be applied to any object. Accordingly, the above-described configurations can be utilized for any object, only if the technique for embedding a collusion-secure code corresponding to identification information into an object is selected in accordance with the object.

Furthermore, the embodiment is also applicable to the case of using “information expressing identification information” having a structure different from that of the collusion-secure code described so far.

Each of the above-described functions can be also realized by software. Further, the embodiment can also be realized as a program for instructing a computer to execute a predetermined means or function, or to enable the computer to function as predetermined means. The embodiment can further be realized as a computer readable recording medium that stores the program.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

1. An identification information embedding apparatus for embedding identification information into an object, comprising:
a first generator which generates, based on the identification information, an identification information polynomial corresponding to the identification information;
an acquisition unit configured to acquire a plurality of remainder polynomials by dividing the identification information polynomial by each of a plurality of relatively prime polynomials, the relatively prime polynomials being pairwise relatively prime, an order of each of the prime polynomials being limited;
a second generator which generates, based on the remainder polynomials, a plurality of integers corresponding to the remainder polynomials, respectively;
a third generator which generates a plurality of component codes corresponding to the integers, respectively;
a fourth generator which generates a collusion-secure code by arranging the component codes in series; and
an embedding unit configured to embed the collusion-secure code into the object.

2. The identification information embedding apparatus according to claim 1, wherein the order of the relatively prime polynomials is identical to each other.

3. The identification information embedding apparatus according to claim 1, wherein the order of each of the relatively prime polynomials is set the order of at least one of the relatively prime polynomials to one.

4. The identification information embedding apparatus according to claim 1, wherein the order of each of the relatively prime polynomials is set to be one.

5. The identification information embedding apparatus according to claim 1, wherein the relatively prime polynomials belong to a plurality of polynomial rings on a finite field, respectively, each of the relatively prime polynomials having the same number of elements.

6. The identification information embedding apparatus according to claim 1, wherein each of the component codes is formed of corresponding minimum bits if a corresponding integer of the integers represents a minimum value, each of the component codes is formed of corresponding maximum bits if a corresponding integer of the integers represents a maximum value, and each of the component codes is formed by arranging the corresponding minimum bits and the corresponding maximum bits in series.

7. The identification information embedding apparatus according to claim 1, wherein the identification information represents an integer.

8. The identification information embedding apparatus according to claim 1, wherein the object represents a copy of a digital content.

9. The identification information embedding apparatus according to claim 1, wherein the object represents a chemical substance.

10. An identification information embedding apparatus for embedding, as watermark information, identification information into an object, comprising:
a first generator which generates, based on the identification information, an element included in a particular ring in which a Chinese remainder theorem holds, the element corresponding to the identification information;
an acquisition unit configured to acquire a plurality of remainders by performing, on the element, an operation corresponding to division, using each of a plurality of prime ideals included in the particular ring, the prime ideals being pairwise relatively prime and having limited norms;
a second generator which generates, based on the remainders, a plurality of integers corresponding to the remainders, respectively;
a third generator which generates a plurality of component codes corresponding to the integers, respectively;
a fourth generator which generates a collusion-secure code by arranging the component codes in series; and
an embedding unit configured to embed the collusion-secure code into the object.

11. The identification information embedding apparatus according to claim 10, wherein the norms of the prime ideals are all identical to each other.

12. The identification information embedding apparatus according to claim 10, wherein at least one of the prime ideals has a minimum norm other than norm 1.

13. The identification information embedding apparatus according to claim 10, wherein all the prime ideals have a minimum norm other than norm 1.

14. The identification information embedding apparatus according to claim 10, wherein each of the component codes is formed of corresponding minimum bits if a corresponding integer of the integers represents a minimum value, each of the component codes is formed of corresponding maximum bits if a corresponding integer of the integers represents a maximum value, and each of the component codes is formed by arranging the corresponding minimum bits and the corresponding maximum bits in series.

15. The identification information embedding apparatus according to claim 10, wherein the identification information represents an integer.

16. The identification information embedding apparatus according to claim 10, wherein the object represents a copy of a digital content.

17. The identification information embedding apparatus according to claim 10, wherein the object represents a chemical substance.

18. An identification information analysis apparatus for acquiring identification information embedded in a plurality of legal copies of a content from a plurality of illegal copies of the content resulting from a collusion attack made on the legal copies of the content, a plurality of collusion-secure codes corresponding to different identification information items being embedded in the legal copies of the content, respectively, comprising:
a code acquisition unit configured to acquire, from a copy of the content, a code extracted as a collusion-secure code;
a division unit configured to divide the code into a plurality of component codes;
a position acquisition unit configured to acquire positional information indicating a position of an altered portion of each of the component codes if each of the component codes is altered, and a reference position in each of the component codes if each of the component codes fails to be altered; and
an information acquisition unit configured to acquire the identification information embedded in the legal copies of the content from the positional information concerning each of the component codes, and reference positional information obtained when all of the component codes of the collusion-secure code corresponding to the identification information fail to be altered,
wherein, in an identification information embedding apparatus for embedding identification information into an object, each of the collusion-secure codes is generated by generating an identification information polynomial corresponding to the identification information, based on the identification information, dividing the identification information polynomial by each of a plurality of relatively prime polynomials corresponding to the identification information to acquire remainder polynomials, generating a plurality of integers corresponding to the remainder polynomials, respectively, based on the remainder polynomials, generating the component codes corresponding to the integers, respectively, and arranging the component codes in series, the relatively prime polynomials being pairwise relatively prime, an order of each of the relatively prime polynomials being limited.

19. An identification information analysis apparatus for acquiring identification information embedded in a plurality of legal copies of a content from a plurality of illegal copies of the content resulting from a collusion attack made on the legal copies of the content, a plurality of collusion-secure codes corresponding to different identification information items being embedded in the legal copies of the content, respectively, comprising:
a code acquisition unit configured to acquire, from a copy of the content, a code extracted as a collusion-secure code;
a division unit configured to divide the code into a plurality of component codes;
a position acquisition unit configured to acquire positional information indicating a position of an altered portion of each of the component codes if each of the component codes is altered, and a reference position in each of the component codes if each of the component codes fails to be altered; and
an information acquisition unit configured to acquire the identification information embedded in the legal copies of the content from the positional information concerning each of the component codes, and reference positional information obtained when all of the component codes of the collusion-secure code corresponding to the identification information fail to be altered,
wherein, an identification information embedding apparatus for embedding, as watermark information, identification information into an object, the collusion-secure code is generated by generating an element included in a particular ring in which a Chinese remainder theorem holds, performing an operation corresponding to division on the element using each of a plurality of prime ideals included in the particular ring, to acquire remainders, generating a plurality of integers corresponding to the remainders, respectively, generating the component codes corresponding to the integers, respectively, and arranging the component codes in series, the prime ideals being pairwise relatively prime and having respective norms limited.

20. An identification information embedding method for embedding identification information into an object, comprising:
generating, based on the identification information, an identification information polynomial corresponding to the identification information;
acquiring a plurality of remainder polynomials by dividing the identification information polynomial by each of a plurality of relatively prime polynomials, the relatively prime polynomial being pairwise relative prime, an order of each of the relatively prime polynomials being limited;
generating, based on the remainder polynomials, a plurality of integers corresponding to the remainder polynomials, respectively;
generating a plurality of component codes corresponding to the integers, respectively;
generating a collusion-secure code by arranging the component codes in series; and
embedding the collusion-secure code into the object.

21. An identification information embedding method for embedding, as watermark information, identification information into an object, comprising:
generating, based on the identification information, an element included in a particular ring in which a Chinese remainder theorem holds, the element corresponding to the identification information;
acquiring a plurality of remainders by performing, on the element, an operation corresponding to division, using each of a plurality of prime ideals included in the particular ring, the prime ideals being pairwise relatively prime and having limited norms;
generating, based on the remainders, a plurality of integers corresponding to the remainders, respectively;
generating a plurality of component codes corresponding to the integers, respectively;
generating a collusion-secure code by arranging the component codes in series; and
embedding the collusion-secure code into the object.

22. An identification information analysis method of acquiring identification information embedded in a plurality of legal copies of a content from a plurality of illegal copies of the content resulting from a collusion attack made on the legal copies of the content, a plurality of collusion-secure codes corresponding to different identification information items being embedded in the legal copies of the content, respectively, comprising:
acquiring, from a copy of the content, a code extracted as a collusion-secure code;
dividing the code into a plurality of component codes;
acquiring positional information indicating a position of an altered portion of each of the component codes if each of the component codes is altered, and a reference position in each of the component codes if each of the component codes fails to be altered; and
acquiring the identification information embedded in the legal copies of the content from the positional information concerning each of the component codes, and reference positional information obtained when all of the component codes of the collusion-secure code corresponding to the identification information fails to be altered,
wherein each of the collusion-secure codes is generated by generating an identification information polynomial corresponding to the identification information, based on the identification information, dividing the identification information polynomial by each of a plurality of relatively prime polynomials corresponding to the identification information to acquire remainder polynomials, generating a plurality of integers corresponding to the remainder polynomials, respectively, based on the remainder polynomials, respectively, generating the component codes corresponding to the integers, respectively, and arranging the component codes in series, the relatively prime polynomials being pairwise relatively prime, an order of each of the relatively prime polynomials being limited.

23. An identification information analysis method of acquiring identification information embedded in a plurality of legal copies of a content from a plurality of illegal copies of the content resulting from a collusion attack made on the legal copies of the content, a plurality of collusion-secure codes corresponding to different identification information items being embedded in the legal copies of the content, respectively, comprising:
acquiring, from a copy of the content, a code extracted as a collusion-secure code;
dividing the code into a plurality of component codes;
acquiring positional information indicating a position of an altered portion of each of the component codes if each of the components is altered, and a reference position in each of the component codes if each of the component codes fails to be altered; and
acquiring the identification information embedded in the legal copies of the content from the positional information concerning each of the component codes, and reference positional information obtained when all of the component codes of the collusion-secure code corresponding to the identification information fails to be altered,
wherein the collusion-secure code is generated by generating an element included in a particular ring in which a Chinese remainder theorem holds, performing an operation corresponding to division on the element using each of a plurality of prime ideals included in the particular ring, to acquire remainders, generating a plurality of integers corresponding to the remainders, respectively, generating component codes corresponding to the integers, respectively, and arranging the component codes in series, the prime ideals being pairwise relatively prime and having respective norms limited.

24. A program stored in a computer readable medium for causing a computer to function as an identification information embedding apparatus for embedding identification information into an object, the program comprising:
means for instructing the computer to generate, based on the identification information, an identification information polynomial corresponding to the identification information;
means for instructing the computer to acquire a plurality of remainder polynomials by dividing the identification information polynomial by each of a plurality of relatively prime polynomials, the relatively prime polynomials being pairwise relatively prime, an order of each of the relatively prime polynomials being limited;
means for instructing the computer to generate, based on the remainder polynomials, a plurality of integers corresponding to the remainder polynomials, respectively;
means for instructing the computer to generate a plurality of component codes corresponding to the integers, respectively;
means for instructing the computer to generate a collusion-secure code by arranging the component codes in series; and
means for instructing the computer to embed the collusion-secure code into the object.

25. A program stored in a computer readable medium for causing a computer to function as an identification information embedding apparatus for embedding identification information into an object, comprising:
means for instructing the computer to generate, based on the identification information, an element included in a particular ring in which a Chinese remainder theorem holds, the element corresponding to the identification information;
means for instructing the computer to acquire a plurality of remainders by performing, on the element, an operation corresponding to division, using each of a plurality of prime ideals included in the particular ring, the prime ideals being pairwise relatively prime and having limited norms;
means for instructing the computer to generate, based on the remainders, a plurality of integers corresponding to the remainders, respectively;
means for instructing the computer to generate a plurality of component codes corresponding to the integers, respectively;
means for instructing the computer to generate a collusion-secure code by arranging the component codes in series; and
means for instructing the computer to embed the collusion-secure code into the object.

26. A program stored in a computer readable medium for causing a computer to function as an identification information analysis apparatus for acquiring identification information embedded in a plurality of legal copies of a content from a plurality of illegal copies of the content resulting from a collusion attack made on the legal copies of the content, a plurality of collusion-secure codes corresponding to different identification information items being embedded in the legal copies of the content, respectively, comprising:
means for instructing the computer to acquire, from a copy of the content, a code extracted as a collusion-secure code;
means for instructing the computer to divide the code into a plurality of component codes;
means for instructing the computer to acquire positional information indicating a position of an altered portion of each of the component codes if each of the component codes is altered, and a reference position in each of the component codes code if each of the component codes fails to be altered; and
means for instructing the computer to acquire the identification information embedded in the legal copies of the content from the positional information concerning each of the component codes, and reference positional information obtained when all of the component codes of the collusion-secure code corresponding to the identification information fail to be altered,
wherein each of the collusion-secure codes is generated by generating an identification information polynomial corresponding to the identification information, based on the identification information, dividing the identification information polynomial by each of a plurality of relatively prime polynomials corresponding to the identification information to acquire remainder polynomials, generating a plurality of integers corresponding to the remainder polynomials, respectively, based on the remainder polynomials, respectively, generating the component codes corresponding to the integers, respectively, and arranging the component codes in series, the relatively prime polynomials being pairwise relatively prime, an order of each of the relatively prime polynomials being limited.

27. A program stored in a computer readable medium for enabling a computer to function as an identification information analysis apparatus for acquiring identification information embedded in a plurality of legal copies of a content from a plurality of illegal copies of the content resulting from a collusion attack made on the legal copies of the content, a plurality of collusion-secure codes corresponding to different identification information items being embedded in the legal copies of the content, respectively, comprising:
means for instructing the computer to acquire, from a copy of the content, a code extracted as a collusion-secure code;
means for instructing the computer to divide the code into a plurality of component codes;
means for instructing the computer to acquire positional information indicating a position of an altered portion of each of the component codes if each of the component codes is altered, and a reference position in each of the component codes if each of the component codes fails to be altered; and
means for instructing the computer to acquire the identification information embedded in the legal copies of the content from the positional information concerning each of the component codes, and reference positional information obtained when all of the component codes of the collusion-secure code corresponding to the identification information fail to be altered,
wherein each of the collusion-secure codes is generated by generating an element included in a particular ring in which a Chinese remainder theorem holds, performing an operation corresponding to division on the element using each of a plurality of prime ideals included in the particular ring, to acquire remainders, generating a plurality of integers corresponding to the remainders, respectively, generating the component codes corresponding to the integers, respectively, and arranging the component codes in series, the prime ideals being pairwise relatively prime and having respective norms limited.
